(19) United States
(12) Patent Application Publication
(10) Pub. No.: US 2010/0330427 A1
(43) Pub. Date: Dec. 30, 2010

(54) NEGATIVE ELECTRODE AND METHOD FOR PRODUCING THE SAME AND NON-AQUEOUS ELECTROLYTE SECONDARY BATTERY

(76) Inventors: Yasutaka Kogetsu, Osaka (JP); Hitoshi Katayama, Osaka (JP)

Correspondence Address: MCDERMOTT WILL & EMERY LLP, 600 13TH STREET, NW, WASHINGTON, DC, 20005-3096, US

(21) Appl. No.: 12/918,755

(22) PCT Filed: Oct. 2, 2009
(86) PCT No.: PCT/JP2009/005111

§ 371 Date: Aug. 20, 2010

(30) Foreign Application Priority Data
Oct. 8, 2008 (JP) 2008-261486 2008

(51) Int. Cl. H01M 4/38; H01M 4/00; B23K 9/16; B23K 10/02

(52) U.S. Cl. 429/220; 429/223; 219/137 R; 219/75; 219/121.46

(57) ABSTRACT

In a negative electrode including a negative electrode plate, a negative electrode lead, and an alloy layer, the negative electrode plate includes a negative electrode current collector and a thin film-like negative electrode active material layer including an alloy-based negative electrode active material and being formed on a surface of the negative electrode current collector; the negative electrode lead contains at least one metal or alloy selected from the group consisting of nickel, nickel alloys, copper, and copper alloys; and the negative electrode current collector and the negative electrode lead are bonded to each other via an alloy layer. As such, in the negative electrode utilizing an alloy-based negative electrode active material, the negative electrode current collector and the negative electrode lead are bonded to each other in an efficient and secured manner, and the conductivity between the negative electrode current collector and the negative electrode lead is improved. As a result, a high capacity negative electrode having good current collecting performance is obtained.

### TECHNICAL FIELD

The present invention relates to a negative electrode and a method for producing the same, and a non-aqueous electrolyte secondary battery. More specifically, the present invention mainly relates to an improvement of a bonding structure between a negative electrode current collector and a negate electrode lead in a negative electrode including an alloy-based negative electrode active material.

### BACKGROUND ART

Non-aqueous electrolyte secondary batteries have a high capacity and a high energy density and can be easily reduced in size and weight, and for this reason, have been widely used as power sources for electronic devices. Examples of electronic devices include cellular phones, personal digital assistants (PDAs), notebook personal computers, video cameras, and portable game machines. A typical non-aqueous electrolyte secondary battery includes a positive electrode including a lithium-cobalt composite oxide, a negative electrode including a carbon material such as graphite, and a polyolefin separator.

The positive electrode and the negative electrode each comprise a current collector, an active material layer, and a lead. The active material layer is formed on the surface of the current collector. The lead is welded to a current collector-exposed portion on which no active material layer is formed. In welding the lead, resistance welding or ultrasonic welding is employed. The current collector-exposed portion is formed by forming active material layers with a space therebetween on the surface of the current collector or removing part of the active material layer formed on the current collector.

Electronic devices are becoming more multifunctional, and the amount of electric power consumption thereof is increasing. Nevertheless, it is expected that such electronic devices can be used continuously for a longer period of time without being charged. In order to meet such an expectation, it is required to increase the capacity of non-aqueous electrolyte secondary batteries, and various attempts are being made to develop an alloy-based negative electrode active material having a capacity higher than those of carbon materials. A typical alloy-based negative electrode active material is a silicon-based active material such as silicon and a silicon oxide.

A negative electrode including an alloy-based negative electrode active material generally comprises a negative electrode current collector, and a thin film of alloy-based negative electrode active material (a thin film-like negative electrode active material layer) formed on the surface of the negative electrode current collector by vapor phase method. Examples of the vapor phase method include vacuum deposition, chemical vapor deposition, and sputtering. The vapor phase method is suitable for uniformly forming a thin film over the entire surface of the negative electrode current collector.

Various methods have been proposed for bonding the negative electrode lead to the negative electrode current collector with a thin film-like negative electrode active material layer formed thereon.

For example, one proposal suggests a negative electrode formed by stacking a negative electrode plate and a negative electrode lead in the thickness direction, and forming a through hole piercing these in the thickness direction, thereby to connect the negative electrode current collector and the negative electrode lead on the inner surface of the through hole (see Patent Literature 1). The through hole of Patent Literature 1 is formed by perpendicularly applying laser beams to the negative electrode plate. Upon laser beam application, the negative electrode current collector and the negative electrode lead exposed on the inner surface of the though hole melt partially to flow on the inner surface of the though hole and contact with each other, and thus the negative electrode current collector and the negative electrode lead are connected to each other.

However, not only the negative electrode current collector and the negative electrode lead but also the negative electrode active material layer exposed on the inner surface of the though hole melt when laser beams are applied. As such, a portion where the negative electrode current collector and the negative electrode lead are connected to each other includes the alloy-based negative electrode active material. Because of this, an increase in electrical resistance, a reduction in conductivity, and the like are likely to occur at the connected portion.

The molten portions of the negative electrode current collector, the negative electrode lead, and the negative electrode active material layer flow on the inner surface of the through hole in the direction of laser beam application. Consequently, the components contained in the molten portions do not disperse uniformly, and the organization of the connected portion after cooling and solidifying becomes non-uniform. Due to this, connection failure or conduction failure becomes more likely to occur. Moreover, the molten portion of the negative electrode current collector and the molten portion of the negative electrode lead are not always reliably connected to each other. This also can be a cause of conductive failure.

Since the through hole formed by laser beam application has a very small diameter, even when the negative electrode current collector and the negative electrode lead are well connected on the inner surface of the through hole, the area of the connected portion is very small. This means that the negative electrode current collector and the negative electrode lead may not be connected to each other to such an extent that enables the battery to operate at full performance. The bonding strength between the negative electrode current collector and the negative electrode lead is not sufficient either. In addition, the alloy-based negative electrode active material included in the negative electrode active material layer expands and contracts repeatedly during repeated charging and discharging, electrical disconnection between the negative electrode current collector and the negative electrode lead occurs with high possibility. The negative electrode of Patent Literature 1 has difficulties in practical use.

Another proposal suggests a negative electrode in which a negative electrode lead made of copper, a copper alloy, or a copper clad material is welded by resistance welding on the surface of a negative electrode active material layer including an alloy-based negative electrode active material (Patent Literature 2). Patent Literature 2 uses the above negative electrode lead for the purpose of improving the bonding between the negative electrode current collector and the negative electrode lead. Patent Literature 2 discloses that part of the negative electrode lead is preferably alloyed at the interface with the negative electrode active material layer.

However, by resistance welding, the alloying will not proceed until the negative electrode current collector and the negative electrode lead are bonded or electrically connected to each other. Even if part of the negative electrode lead is alloyed, the negative electrode active material layer is hardly alloyed. As such, the bonding between the negative electrode current collector and the negative electrode lead becomes insufficient, and the bonding strength therebetween is low. Moreover, in battery fabrication, in battery operation, and the like, electrical disconnection between the negative electrode lead and the negative electrode current collector occurs with high possibility. Further, the current collecting performance of the negative electrode may significantly deteriorate.

### CITATION LIST

### Patent Literature

### [PTL 1] Japanese Laid-Open Patent Publication No. 2007-214086

### [PTL 2] Japanese Laid-Open Patent Publication No. 2007-115421

### SUMMARY OF INVENTION

### Technical Problem

Providing a current collector-exposed portion on the surface of a negative electrode current collector by a vapor phase method requires complicated procedures. For example, one possible method is to form a mask layer at a predetermined position of the surface of the negative electrode current collector and remove the mask layer after formation of a thin film. The portion from which the mask layer is removed serves as the current collector-exposed portion. This method requires extra procedures such as the formation of a mask layer and the removal of the mask layer.

Forming a current collector-exposed portion by partially removing a thin film of alloy-based negative electrode active material is also very difficult. In particular, a thin film of silicon-based active material is vitreous, has a high mechanical strength, and strongly adheres onto the surface of the negative electrode current collector. When such a vitreous thin film is removed from the negative electrode current collector, the negative electrode current collector may be damaged, resulting in deterioration of the current collecting performance thereof and the electrode performance.

It would be possible to bring a negative electrode lead into contact with a thin film of alloy-based negative electrode active material, and weld the contact portion by resistance welding or ultrasonic welding. When this method is employed, since the thin film of alloy-based negative electrode active material interposed between the negative electrode lead and the negative electrode current collector has a comparatively high electric resistance, the electrical conductivity between the negative electrode current collector and the negative electrode lead may become insufficient, causing the battery performance to deteriorate. Moreover, the bonding between the negative electrode current collector and the negative electrode lead may become insufficient, causing electrical disconnection.

In short, it is very difficult to efficiently and reliably bond the negative electrode current collector and the negative electrode lead to each other in a negative electrode including a thin film-like negative electrode active material layer composed of an alloy-based negative electrode active material.

The present invention intends to provide: a negative electrode for a non-aqueous electrolyte secondary battery using an alloy-based negative electrode active material, in which the negative electrode current collector and the negative electrode lead are efficiently and reliably bonded to each other; a method for producing the same; and a non-aqueous electrolyte secondary battery including the above negative electrode and having a high capacity and a high output power.

### Solution to Problem

The present invention provides a negative electrode including a negative electrode current collector, a thin film-like negative electrode active material layer, a negative electrode lead, and an alloy layer. In the negative electrode of the present invention, the thin film-like negative electrode active material layer is formed on a surface of the negative electrode current collector and includes an alloy-based negative electrode active material. The negative electrode lead contains at least one metal or alloy selected from the group consisting of nickel, nickel alloys, copper, and copper alloys. The alloy layer is interposed between the negative electrode current collector and the negative electrode lead, to bond the negative electrode current collector and the negative electrode lead.

The present invention provides a method for producing the above negative electrode. The method for producing a negative electrode of the present invention includes a first step, a second step and a third step. In the first step, a thin film-like negative electrode active material layer including an alloy-based negative electrode active material is formed on a surface of a negative electrode current collector, to prepare a negative electrode plate. In the second step, the thin film-like negative electrode active material layer obtained in the first step is brought into contact with a negative electrode lead containing at least one metal or alloy selected from the group consisting of nickel, nickel alloys, copper, and copper alloys. In the third step, at least part of a portion where the thin film-like negative electrode active material layer is in contact with the negative electrode lead is arc welded.

The present invention provides a non-aqueous electrolyte secondary battery including: a positive electrode including a positive electrode current collector, a positive electrode active material layer being formed on a surface of the positive electrode current collector and including a positive electrode active material, and a positive electrode lead bonded to the positive electrode current collector; the negative electrode as described above; a separator interposed between the positive electrode and the negative electrode; a non-aqueous electrolyte with lithium ion conductivity; and a battery case.

### ADVANTAGEOUS EFFECTS OF INVENTION

The negative electrode of the present invention has a high capacity and a high energy density. According to the method for producing a negative electrode of the present invention, the negative electrode of the present invention can be produced efficiently and industrially advantageously. The non-aqueous electrolyte secondary battery of the present invention, because of including the negative electrode of the present invention, has a high capacity and a high output power and is excellent in battery performance such as output characteristics and cycle characteristics.

While the novel features of the invention are set forth particularly in the appended claims, the invention, both as to organization and content, will be better understood and appreciated, along with other objects and features thereof, from the following detailed description taken in conjunction with the drawings.

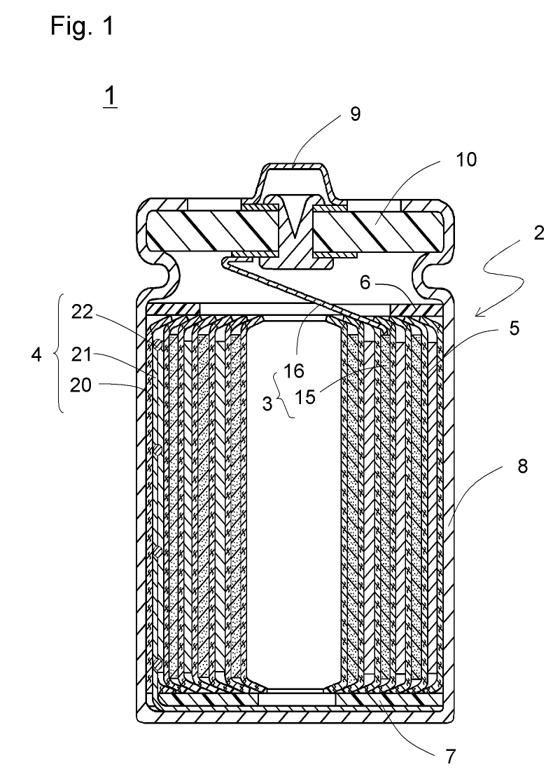

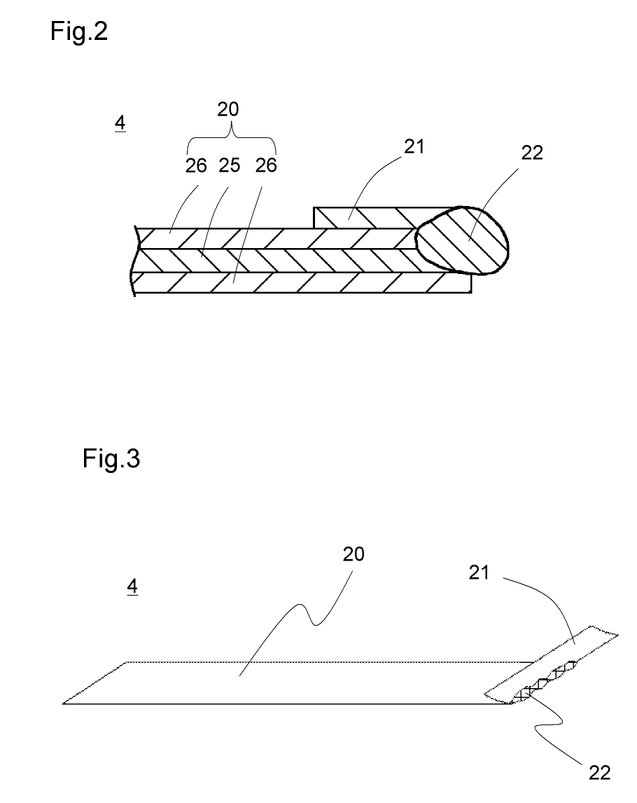

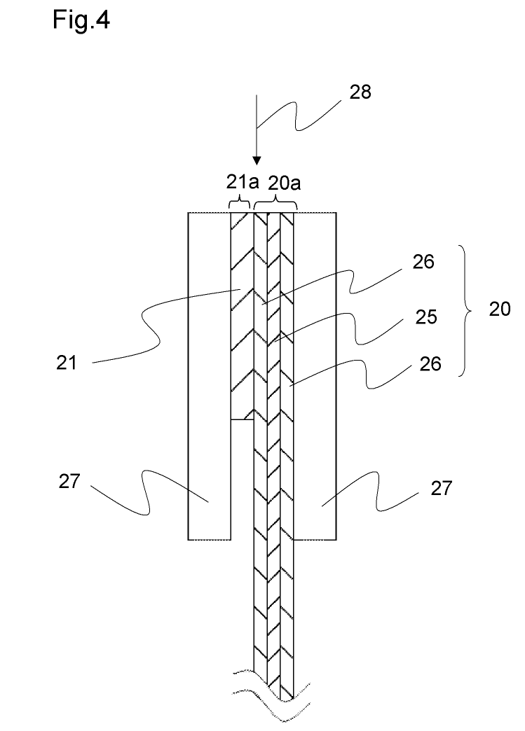

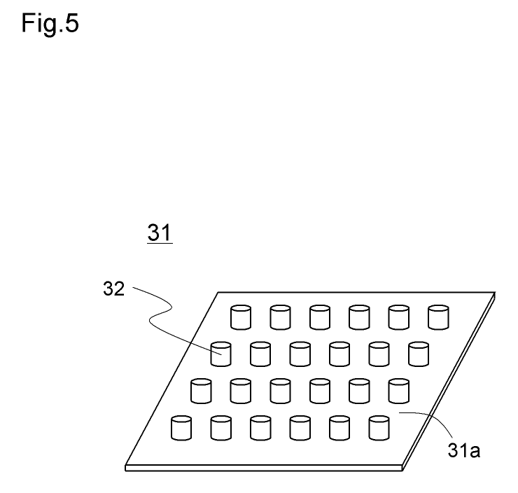

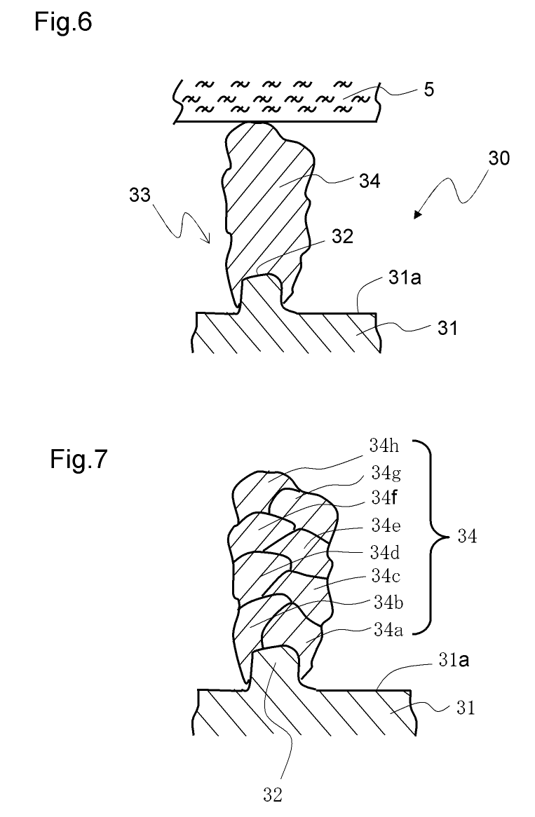

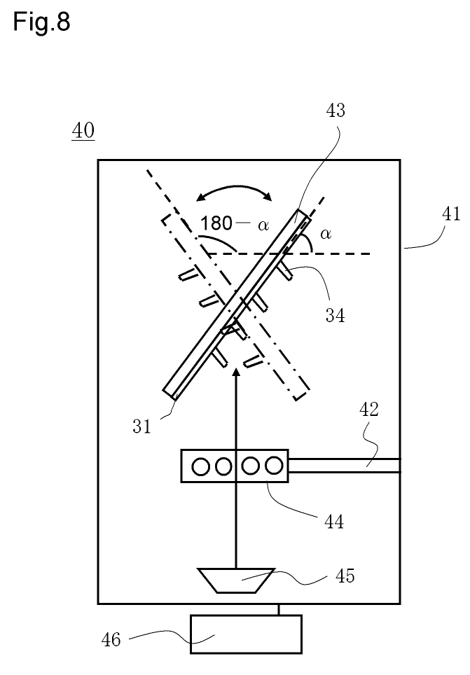

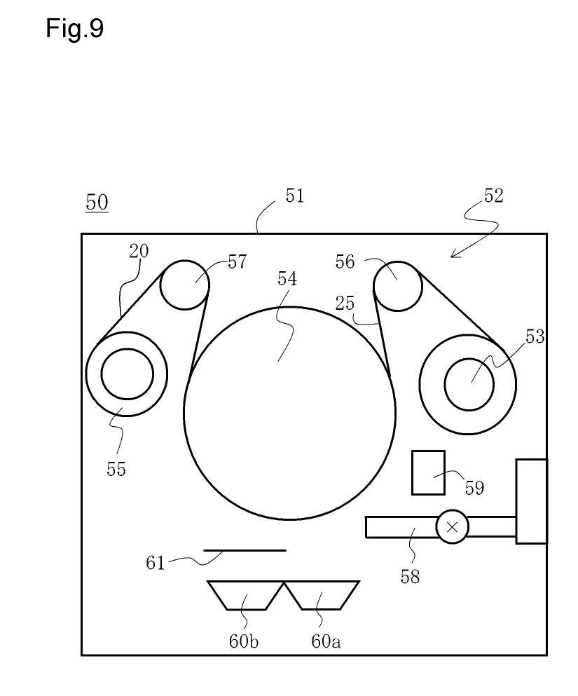

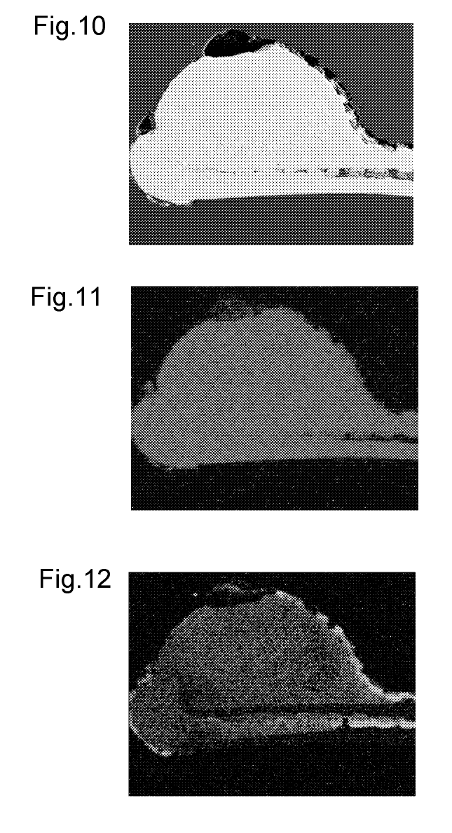

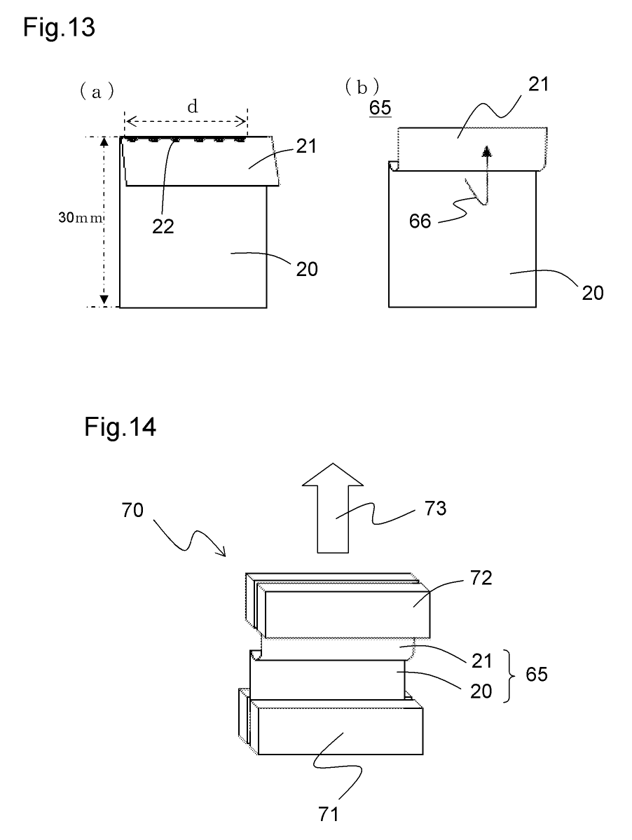

### BRIEF DESCRIPTION OF DRAWINGS

[FIG. 1] A longitudinal cross-sectional view schematically showing the configuration of a non-aqueous electrolyte secondary battery being one embodiment of the present invention.

[FIG. 2] A cross-sectional view schematically showing the configuration of an essential part of a negative electrode being another embodiment of the present invention.

[FIG. 3] A perspective view schematically showing the appearance of the negative electrode shown in FIG. 2.

[FIG. 4] A longitudinal cross-sectional view explaining a preferred embodiment of the second step and the third step of a method for producing a negative electrode of the present invention.

[FIG. 5] A perspective view schematically showing the configuration of a negative electrode current collector of another embodiment.

[FIG. 6] A longitudinal cross-sectional view schematically showing the configuration of a negative electrode of another embodiment.

[FIG. 7] A longitudinal cross-sectional view schematically showing the configuration of a negative electrode active material layer of the negative electrode shown in FIG. 6.

[FIG. 8] A side view schematically showing the configuration of an electron beam vapor deposition apparatus for forming the negative electrode active material layer shown in FIG. 7.

[FIG. 9] A side view schematically showing the configuration of a vapor deposition apparatus of another embodiment.

[FIG. 10] A scanning electron micrograph of a cross section of an alloy layer in a negative electrode of Example 1.

[FIG. 11] An element map of copper in the cross section of the alloy layer shown in FIG. 10.

[FIG. 12] An element map of silicon in the cross section of the alloy layer shown in FIG. 10.

[FIG. 13] A set of perspective views schematically showing a method of preparing a sample used for measuring a tensile strength of the negative electrode lead from the negative electrode current collector.

[FIG. 14] A perspective view schematically showing a method of measuring a tensile strength of the negative electrode lead from the negative electrode current collector.

### DESCRIPTION OF EMBODIMENTS

In the course of studying for solving the above-discussed problems, the present inventors have noted the configuration as disclosed in Patent Literature 2, in which a negative electrode current collector and a negative electrode lead are bonded to each other with a thin film-like negative electrode active material layer including an alloy-based negative electrode active material interposed therebetween. As a result of further studies, the present inventors have arrived at a new configuration. In this configuration, a metal or a metal alloy selected from nickel, nickel alloys, copper and copper alloys is used as the negative electrode lead. In bonding the negative electrode current collector and the negative electrode lead to each other with the thin film-like negative electrode active material layer interposed therebetween, arc welding is employed.

According to this configuration, at least part of the thin film-like negative electrode active material layer interposed between the negative electrode current collector and the negative electrode lead is almost uniformly alloyed, providing a strong bonding between the negative electrode current collector and the negative electrode lead without sacrificing the current collecting performance of the negative electrode. In such a bonding, presumably, a metal element contained in the negative electrode current collector and/or the negative electrode lead, in particular, a metal element contained in negative electrode lead is uniformly mixed with a semimetal element contained in the thin film-like negative electrode active material layer, forming an alloy layer.

The present inventors have found that the thin film-like negative electrode active material layer is alloyed only at a portion sandwiched between the negative electrode current collector and the negative electrode lead, where arc welding is applied, and a large portion of the thin film-like negative electrode active material layer remains unalloyed. The present inventors have also found that the negative electrode current collector and the negative electrode lead are strongly bonded to each other without reducing the capacity and output power of the battery. The present inventors have completed the present invention based on these findings.

The negative electrode of the present invention includes an alloy-based negative electrode active material and has a high capacity and a high energy density, and therefore can contribute to achieve a higher capacity and a higher output power of non-aqueous electrolyte secondary batteries. In the negative electrode of the present invention, the negative electrode current collector and the negative electrode lead are bonded to each other with the alloy layer interposed therebetween. By virtue of this, the bonding and conductivity between the negative electrode current collector and the negative electrode lead are very good. The negative electrode of the present invention is also excellent in current collecting performance.

According to the production method of a negative electrode of the present invention, the negative electrode of the present invention can be produced efficiently and industrially advantageously. In the production method of the present invention, alloying occurs in the third step, which makes it possible to reduce the bonding temperature between the negative electrode current collector and the negative electrode lead. In this respect also, the production method of a negative electrode of the present invention is industrially advantageous.

The non-aqueous electrolyte secondary battery of the present invention includes the negative electrode of the present invention, and, therefore, has a high capacity and a high output power and is excellent in battery performance such as output characteristics and cycle characteristics. In addition, since the negative electrode current collector and the negative electrode lead are strongly bonded to each other in the negative electrode, and thus the current collecting performance, the output characteristics, and the like of the negative electrode can be maintained over a long period of time at a high level, the non-aqueous electrolyte secondary battery of the present invention has a long service life.

The negative electrode of the present invention comprises a negative electrode current collector, a thin film-like negative electrode active material layer, a negative electrode lead, and an alloy layer. The thin film-like negative electrode active material layer includes an alloy-based negative electrode active material. The negative electrode current collector and the negative electrode lead are bonded to each other via the alloy layer. The areas where the alloy layer is in contact with the negative electrode current collector and the negative electrode lead are comparatively large. As such, the negative electrode current collector and the negative electrode lead are strongly bonded to each other. Since the alloy layer is low in electric resistance, the current collecting performance of the negative electrode will not be impaired.

The non-aqueous electrolyte secondary battery of present invention is characterized by including the negative electrode of the present invention, and except this, may have the same configuration as that of the conventional non-aqueous electrolyte secondary battery.

FIG. 1 is a longitudinal cross-sectional view schematically showing the configuration of a non-aqueous electrolyte secondary 1 being one embodiment of the present invention. FIG. 2 is a cross-sectional view schematically showing the configuration of an essential part of a negative electrode 4 being another embodiment of the present invention. FIG. 2 is a cross-sectional view along the thickness direction of the negative electrode 4 showing an end portion thereof in the longitudinal direction thereof. FIG. 3 is a perspective view schematically showing the appearance of the negative electrode 4 shown in FIG. 2.

The non-aqueous electrolyte secondary battery 1 of this embodiment includes a wound electrode assembly 2, an upper insulating plate 6 and a lower insulating plate 7 attached to both ends of the wound electrode assembly 2 in its longitudinal direction, respectively, a battery case 8 accommodating the wound electrode assembly 2 and others, a sealing plate 10 sealing the battery case 8, a positive electrode terminal 9 supported by the sealing plate 10, and a non-aqueous electrolyte (not shown).

The upper insulating plate 6 and the lower insulating plate 7 are attached to both ends of the wound electrode assembly 2 in its longitudinal direction, and these are accommodated in the battery case 8. At this time, a positive electrode lead 16 of the positive electrode 3 and a negative electrode lead 21 of the negative electrode 4 are each connected to a predetermined point. The non-aqueous electrolyte is injected into the battery case 8. Next, the sealing plate 10 supporting the positive electrode terminal 9 is attached to the opening of the battery case 8, and the opening end of the battery case 8 is crimped onto the sealing plate 10. By doing this, the battery case 8 is sealed, and thus the non-aqueous electrolyte secondary battery 1 is obtained.

The wound electrode assembly 2 includes a belt-like positive electrode 3, a belt-like negative electrode 4, and a belt-like separator 5. The wound electrode assembly 2 can be obtained, for example, by laminating the positive electrode 3 and the negative electrode 4 with the separator 5 interposed therebetween and winding the laminate from one end thereof in the longitudinal direction. In this embodiment, the electrode assembly is the wound electrode assembly 2, but not limited thereto, and may be a stacked electrode assembly obtained by stacking the positive electrode 3 and the negative electrode 4 with the separator 5 interposed therebetween.

The positive electrode 3 includes a positive electrode plate 15 and the positive electrode lead 16.

The positive electrode plate 15 includes a positive electrode current collector and positive electrode active material layer.

The positive electrode current collector may be any conductive substrate commonly used in the field of non-aqueous electrolyte secondary batteries. The conductive substrate may be made of, for example, a metal material such as stainless steel, titanium, aluminum, and aluminum alloy, or a conductive resin. The conductive substrate may be a porous conductive substrate, a non-porous conductive substrate, and the like.

Examples of the porous conductive substrate include mesh, net, punched sheet, lath, porous material, foam, and nonwoven fabric. Examples of the non-porous conductive substrate include foil and film. The thickness of the conductive substrate is not particularly limited, and is usually 1 to 500 μm, preferably 1 to 50 μm, and more preferably 10 to 30 μm.

The positive electrode active material layer is provided on both surfaces of the positive electrode current collector in its thickness direction in this embodiment, but not limited thereto and may be provided on one surface of the positive electrode current collector in its thickness direction. The positive electrode active material layer includes a positive electrode active material and may further include a conductive agent, a binder, and the like.

For the positive electrode active material, any material capable of absorbing and desorbing lithium ions may be used without any limitation, but a lithium-containing composite metal oxide, an olivine type lithium phosphate, and the like are preferred.

The lithium-containing composite metal oxide is a metal oxide containing lithium and a transition metal element or a metal oxide in which part of the transition metal element in the metal oxide is substituted by a different element.

Examples of the transition metal element include Sc, Y, Mn, Fe, Co, Ni, Cu, and Cr, among which Mn, Co, Ni, and the like are preferred. Examples of the different element include Na, Mg, Zn, Al, Pb, Sb, and B, among which Mg, Al, and the like are preferred. These transition metal elements may be used singly or in combination of two or more; and these different elements may be used singly or in combination of two or more.

Examples of the lithium-containing composite oxide include Li₁CoO₂, LiₗNiO₂, LiₗMnO₂, LiₗCoₘNi₁₋ₘO₂, LiₗCoₘA₁₋ₘOₙ, LiₗNi₁₋ₘAₘOₙ, LiₗMn₂O₄, and LiₗMn₂₋ₘAₙO₄, where A represents at least one element selected from the group consisting of Sc, Y, Mn, Fe, Co, Ni, Cu, Cr, Na, Mg, Zn, Al, Pb, Sb and B, 0<l≦1.2, m=0 to 0.9, and n=2.0 to 2.3.

Among these, lithium-containing composite oxides represented by LiₗCoₘA₁₋ₘOₙ, where A, l, m and n are the same as above, are preferred. In each formula, “l” represents a molar ratio of lithium in the positive electrode active material immediately after production, and increases or decreases during charging and discharging. There may be a case where the lithium-containing composite oxide includes an oxygen-deficient portion or an oxygen-surplus portion.

Examples of the olivine-type lithium phosphate include LiXPO₄ and Li₂XPO₄F, where X represents at least one element selected from the group consisting of Co, Ni, Mn and Fe.

The positive electrode active materials may be used singly or in combination of two or more.

The conductive agent may be any conductive agent commonly used in the field of non-aqueous electrolyte secondary batteries, examples of which include graphites such as natural graphite and artificial graphite; carbon blacks such as acetylene black, Ketjen black, channel black, furnace black, lamp black, and thermal black; conductive fibers such as carbon fiber and metal fiber; fluorinated carbon; metal powders such as aluminum; conductive whiskers such as zinc oxide whisker and potassium titanate whisker (e.g., trade name: DENTALL, available from Otsuka Chemical Co., Ltd.); conductive metal oxides such as titanium oxide; and organic conductive materials such as phenylene derivative. These conductive agents may be used singly or in combination of two or more.

The binder may be any binder commonly used in the field of non-aqueous electrolyte secondary batteries, examples of which include polyvinylidene fluoride, polytetrafluoroethylene, polyhexafluoropropylene, polyethylene, polypropylene, polyamide, polyimide, polyamide-imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyether sulfone, styrene-butadiene rubber, modified acrylic rubber, and carboxymethylcellulose.

Alternatively, the binder may be a copolymer containing at least two monomer compounds. Examples of the monomer compound include tetrafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene. These binders may be used singly or in combination of two or more.

The positive electrode active material layer can be formed, for example, by applying a positive electrode material mixture slurry onto a surface of the positive electrode current collector, followed by drying and rolling. In such a manner, the positive electrode plate 15 is obtained. The positive electrode material mixture slurry can be prepared by dissolving or dispersing the positive electrode active material and, as appropriate, the conductive agent, the binder, and the like in an organic solvent. For the organic solvent, dimethylformamide, dimethylacetamide, methylformamide, N-methyl-2-pyrrolidone, dimethylamine, acetone, cyclohexanone, and the like may be used.

One end of the positive electrode lead 16 is connected to the positive electrode current collector, and the other end thereof is connected to the positive electrode terminal 9. The positive electrode lead 16 is connected to the positive electrode current collector by welding the positive electrode lead 16 to a current collector-exposed portion on the positive electrode current collector. The current collector-exposed portion is formed by intermittently applying the positive electrode material mixture slurry onto the positive electrode current collector surface or partially removing the positive electrode active material layer formed on the positive electrode current collector surface. Likewise, the positive electrode lead 16 may be connected to the positive electrode terminal 9 by welding the positive electrode lead 16 to the positive electrode terminal 9. The welding of the positive electrode lead 16 is performed by resistance welding, ultrasonic welding, and the like.

The positive electrode lead 16 is made of aluminum, an aluminum alloy, and the like. Examples of the aluminum alloy include aluminum-silicon alloys, aluminum-iron alloys, aluminum-copper alloys, aluminum-manganese alloys, aluminum-magnesium alloys, and aluminum-zinc alloys.

The negative electrode 4 includes a negative electrode plate 20, the negative electrode lead 21, and an alloy layer 22.

The negative electrode plate 20 includes a negative electrode current collector 25 and a thin film-like negative electrode active material layer 26 as shown in FIG. 2.

For the negative electrode current collector 25, any non-porous conductive substrate commonly used in the field of non-aqueous electrolyte secondary batteries may be used.

The non-porous conductive substrate may be in the form of foil, sheet, film, and the like. Among these, foil is preferred. The conductive substrate is made of stainless steel, titanium, nickel, copper, a copper alloy, and the like. Among these, copper and a copper alloy are preferred, and a copper alloy is more preferred. Examples of the copper foil include rolled copper foil and electrolytic copper foil. The thickness of the conductive substrate is usually 1 to 500 μm, preferably 1 to 50 μm, more preferably 10 to 40 μm, and much more preferably 10 to 30 μm.

The negative electrode current collector 25 contains a metal element. Examples of the metal element include iron, titanium, nickel, and copper. Among these, nickel and copper are preferred, and copper is more preferred, in view of allowing the semimetal element contained in an alloy-based negative electrode active material to be uniformly dispersed.

The thin film-like negative electrode active material layer 26 (hereinafter simply referred to as the “negative electrode active material layer 26”) includes an alloy-based negative electrode active material. The negative electrode active material layer 26 may include, in addition to the alloy-based negative electrode active material, any known negative electrode active material other than the alloy-based negative electrode active material, an additive, and the like in an amount within a range that does not impair the characteristics of the negative electrode active material layer 26. The negative electrode active material layer 26 is formed on both surfaces of the negative electrode current collector 25 in its thickness direction in this embodiment, but may be formed on one of both surfaces of the negative electrode current collector 25. A preferred negative electrode active material layer 26 is in the form of an amorphous or low crystalline thin film including an alloy-based negative electrode active material and having a film thickness of 3 to 50 μm.

The alloy-based negative electrode active material absorbs lithium by alloying with lithium during charging and desorbs lithium during discharging, at a negative electrode potential. For the alloy-based negative electrode active material, any known alloy-based active material may be used without limitation, and for example, a silicon-based active material, a tin-based active material, and the like may be used. The silicon-based active material mainly contains silicon as a semimetal element. The tin-based active material mainly contains tin as a semimetal element.

Examples of the silicon-based active material include silicon, silicon oxides, silicon carbides, silicon nitrides, and silicon alloys; partial substitution products of these; and solid solutions of these. Among these, silicon oxides are preferred.

Examples of the silicon oxides include silicon oxides represented by the formula: SiOₐ, where 0.05<a<1.95. Examples of the silicon carbides include silicon carbides represented by the formula: SiC_{b}, where 0<b<1. Examples of the silicon nitrides include silicon nitrides represented by the formula: SiN_{c}, where 0<c<4/3.

The silicon alloy is an alloy of silicon and a different element A. The different element A is at least one element selected from the group consisting of Fe, Co, Sb, Bi, Pb, Ni, Cu, Zn, Ge, In, Sn, and Ti. The partial substitution product is a compound in which part of silicon in the silicon-based active material is substituted by a different element B. The different element B is at least one element selected from the group consisting of B, Mg, Ni, Ti, Mo, Co, Ca, Cr, Cu, Fe, Mn, Nb, Ta, V, W, Zn, C, N, and Sn.

Examples of the tin-based active material include tin, tin oxides, tin nitrides, tin alloys, tin compounds, and solid solutions of these, among which tin oxides are preferred. Examples of the tin oxides include tin oxides represented by SnO_{d}, where 0<d<2, and SnO₂. Examples of the tin alloys include Ni—Sn alloys, Mg—Sn alloys, Fe—Sn alloys, Cu—Sn alloys, and Ti—Sn alloys. Examples of the tin compounds include SnSiO₃, NiSn₄, and Mg₂Sn.

Examples of the semimetal element contained in the alloy-based negative electrode active material include silicon and tin. Among these, silicon is preferred in view of the uniform dispersion in the alloy layer 22 and the suppression of an increase in the electrical resistance of the alloy layer 22 as described below.

The alloy-based negative electrode active materials may be used singly or in combination of two or more.

The negative electrode active material layer 26 is preferably formed on a surface of the negative electrode current collector 25 in the form of a thin film by a vapor phase method. Examples of the vapor phase method include vacuum deposition, sputtering, ion plating, laser ablation, chemical vapor deposition (CVD), plasma chemical vapor deposition, and flame spray coating. Among these, vacuum vapor deposition is preferred. According to the vacuum vapor deposition, the negative electrode active material layer 26 is formed by using a vapor deposition apparatus 40 as shown in FIG. 8.

One end of the negative electrode lead 21 is bonded to the negative electrode current collector 25 with the alloy layer 22 interposed therebetween, and the other end thereof is connected to the inner bottom surface of the battery case 8 also serving as a negative electrode terminal. The bonding strength between the negative electrode lead 21 and the negative electrode current collector 25, expressed as the tensile strength of the negative electrode lead 21 from the negative electrode current collector 25 (hereinafter simply referred to as the “tensile strength of the negative electrode lead 21”), is 0.3 N or more per mm of bonded width.

Specifically, for example, when the negative electrode lead 21 is a copper lead having a thickness of 20 to 30 μm, the tensile strength of the negative electrode lead 21 is 0.3 to 15 N per mm of bonded width. The tensile strength of the negative electrode lead 21 is proportional to the thickness of the negative electrode lead 21 and the thickness of the negative electrode current collector 25, and can reach 25 N per mm of bonded width at maximum. The measuring method of the tensile strength will be described in detail in Examples.

The negative electrode lead 21 contains at least one metal or an alloy selected from the group consisting of nickel, nickel alloys, copper and copper alloys.

Examples of the nickel alloys include nickel-silicon alloys, nickel-tin alloys, nickel-cobalt alloys, nickel-iron alloys, and nickel-manganese alloys.

Examples of the copper alloys include copper-nickel alloys, copper-iron alloys, copper-silver alloys, copper-phosphorus alloys, copper-aluminum alloys, copper-silicon alloys, copper-tin alloys, copper-zirconia alloys, and copper-beryllium alloys. The copper alloys may be used as the material for the negative electrode current collector 25.

Among the nickel alloys and the copper alloys, nickel-silicon alloys, nickel-tin alloys, copper-silicon alloys, copper-tin alloys, copper-nickel alloys, and the like are preferred; and nickel-silicon alloys, copper-silicon alloys, and copper-nickel alloys are more preferred. Among the above-listed alloys, the alloys other than copper-nickel alloys are alloys of nickel or copper and a semimetal element such as silicon and tin. The semimetal element is contained in a silicon-based active material or a tin-based active material used as the alloy-based negative electrode active material.

The negative electrode lead 21 is preferably made of nickel, copper, or a copper-nickel alloy. Among these, copper is preferred. Alternatively, it may be made of a clad material of copper and nickel. The negative electrode lead 21 is made by forming the above exemplified metal or alloy into the form of a commonly used lead.

The negative electrode lead 21 contains at least one selected from nickel and copper as a metal element. Among these, copper is preferred, in view of allowing the semimetal element contained in the alloy-based negative electrode active material to be uniformly dispersed. The negative electrode lead 21 may contain a metal element capable of alloying with nickel or copper, in addition to one selected from nickel and copper. Examples of the metal element capable of alloying with nickel or copper include cobalt, iron, manganese, silver, copper, aluminum, zirconium, and beryllium.

The alloy layer 22 is interposed between the negative electrode current collector 25 and the negative electrode lead 21 as shown in FIGS. 1 to 3, to bond the negative electrode current collector 25 and the negative electrode lead 21 and to electrically connect the negative electrode current collector 25 and the negative electrode lead 21. In this embodiment, a plurality of alloy layers 22 are formed at predetermined intervals on the region where the negative electrode current collector 25 and the negative electrode lead 21 are adjacent to each other.

One alloy layer 22 or a plurality of alloy layers 22 may be formed. In view of the bonding strength between the negative electrode lead 21 and the negative electrode current collector 25, it is preferable to form a plurality of alloy layers 22. The alloy layer 22 may be formed on almost the entire region where the negative electrode current collector 25 and the negative electrode lead 21 are adjacent to each other.

The alloy layer 22 is presumably formed only when, while the negative electrode active material layer 26 and the negative electrode lead 21 are kept in contact with each other, arc welding is applied to at least part of the contact portion therebetween. In arc welding, an area over which the arc welding energy is applied melt, forming a molten portion. The area over which the arc welding energy is applied is an area consisting of: at least part of the interface between the negative electrode current collector 25 and the negative electrode active material layer 26, and a region therearound; at least part of the negative electrode active material layer 26; and at least part of the contact portion between the negative electrode active material layer 26 and the negative electrode lead 21, and a region therearound. Presumably, as a result, the molten portion extending from the negative electrode current collector 25 to the negative electrode lead 21 is formed.

In the above molten portion, the metal elements or semimetal elements contained in the negative electrode lead 21, the negative electrode current collector 25 and the negative electrode active material layer 26 are dispersed, and at least part of the metal elements or semimetal elements are alloyed. The alloy layer 22 is presumably formed by this mechanism. As such, the alloy layer 22 may contain, in addition to an alloy, a metal element or semimetal element that remains unalloyed. As long as arc welding is employed, the content of the semimetal element in the alloy layer 22 is not so large as to affect the bonding and conductivity between the negative electrode current collector 25 and the negative electrode lead 21.

There may be a case where part of the negative electrode active material layer 26 may remain as it is without melting in the interior of the formed alloy layer 22, depending on the welding conditions of arc welding. However, as long as the alloy layer 22 is formed by arc welding, the negative electrode active material layer 26 remaining in the interior of the alloy layer 22, if any, will not cause the bonding and conductivity provided by the alloy layer 22, between the negative electrode current collector 25 and the negative electrode lead 21, to fall below the practical range.

In contrast, in resistance welding, since the resistance of the negative electrode active material layer 26 is too high, electric current will not flow through the negative electrode active material layer 26. Because of this, when resistance welding is performed, although part of the negative electrode current collector 25 may melt locally at an interface between the negative electrode current collector 25 and the negative electrode active material layer 26, and part of the negative electrode lead 21 may melt locally at a contact portion between the negative electrode active material layer 26 and the negative electrode lead 21, a region extending from the negative electrode current collector 25 through the negative electrode active material layer 26 to the negative electrode lead 21 will not melt. When ultrasonic welding is performed, the results are similar to when resistance welding is performed.

In short, in resistance welding and supersonic wave resistance welding, the negative electrode current collector 25 and/or the negative electrode lead 21 locally melt only, and the negative electrode active material layer 26 does not melt. As such, the negative electrode current collector 25 and the negative electrode lead 21 cannot be bonded to each other. Even if they appear to be bonded to each other in appearance, electrical disconnection would occur without fail in a subsequent process such as fabrication of a battery. Resistance welding and supersonic wave welding are welding methods that are commonly employed to bond a lead to a current collector-exposed portion.

The alloy layer 22 contains an alloy as a main component, and by virtue of this, the negative electrode current collector 25 is integrated with the negative electrode lead 21, forming a strong bonding between the negative electrode current collector 25 and the negative electrode lead 21. In addition, since the alloy layer 22 contains an alloy, the negative electrode current collector 25 and the negative electrode lead 2 are electrically connected to each other.

The alloy contained in the alloy layer 22 is, for example, an alloy (A) of a metal element and a semimetal element. The semimetal element is, for example, a semimetal element contained in the alloy-based negative electrode active material. The metal element is, for example, at least one metal element selected from the metal elements contained in the negative electrode current collector 25 and in the negative electrode lead 21. Examples of the alloy (A) include Cu—Si alloys, Ni—Si alloys, Cu—Sn alloys, and Ni—Sn alloys. The content of the alloy in the alloy layer 22 is 0.1 wt % or more of the total weight of the alloy layer 22, preferably 1 wt % or more of the total weight of the alloy layer 22, and more preferably 1 wt % to 40 wt % of the total weight of the alloy layer 22.

When the alloy-based negative electrode active material contains a metal element in addition to the semimetal element, there may be a case where the alloy layer 22 contains the metal element. When the negative electrode current collector 25 and/or the negative electrode lead 21 contain a semimetal element in addition to the metal element, there may be a case where the alloy layer 22 contains the semimetal element. When the negative electrode current collector 25 and/or the negative electrode lead 21 contain a nickel alloy containing nickel and a metal element other than nickel, or a copper alloy containing copper and a metal element other than copper, there may be a case where the alloy layer 22 contains two or more metal elements. There may be a case where the alloy layer 22 contains inevitable impurities contained in the negative electrode current collector 25, the negative electrode lead 21 or the negative electrode active material layer 26.

When the negative electrode active material layer 26 includes a silicon-based active material, it is preferable to allow the negative electrode active material layer 26 to absorb lithium, preferably to absorb lithium in an amount equivalent to the irreversible capacity, prior to bringing the negative electrode active material layer 26 into contact with the negative electrode lead 21 to perform arc welding. This provides a uniform thickness of the alloy layer 22 and further increases the bonding strength and conductive performance between the negative electrode current collector 25 and the negative electrode lead 21.

The reason for this has not been made fully clear, but is presumed as follows. Due to the presence of lithium in the negative electrode active material layer 26, the melting temperatures of silicon and the like contained in the silicon-based active material become low. Consequently, in the negative electrode current collector 25, the negative electrode active material layer 26, and the negative electrode lead 21, an area over which the arc welding energy is applied are easy to melt, and presumably for this reason, the bonding strength and the conductive performance between the negative electrode current collector 25 and the negative electrode lead 21 are further increased.

When arc welding is performed after allowing the negative electrode active material layer 26 to absorb lithium, there may be a case where the resultant alloy layer 22 contains an alloy (B) of lithium and a semimetal element in addition to the alloy (A.). The semimetal element contained in the alloy (B) is, for example, a semimetal element contained the alloy-based negative electrode active material. Examples of the alloy (B) include Li—Si alloys and Li—Sn alloys.

At least part of the alloy layer 22 is in contact with the negative electrode active material layer 26. However, the negative electrode active material layer 26, because of including the alloy-based negative electrode active material, has an electrical resistance that is higher than those of metals and alloys, and has an electrical resistance that is higher than that of the alloy layer 22. As such, even when the alloy layer 22 and the negative electrode active material layer 26 are in contact with each other, there is no electrical connection therebetween. This does not fail to establish electrical connection between the negative electrode current collector 25 and the negative electrode lead 21, and will not result in deterioration of the current collecting performance of the negative electrode 4.

It suffices if the alloy layer 22 is formed in a region extending from at least part of the negative electrode current collector 25 to at least part of the negative electrode lead 21 in the thickness direction of the negative electrode 4. When the negative electrode active material layer 26 is formed on the surfaces of both sides of the negative electrode current collector 25 in its thickness direction, one end of the alloy layer 22 may reach one of the negative electrode active material layers 26 opposite to the other one of the negative electrode active material layers 26 being in contact with the negative electrode lead 21; and the other end of the alloy layer 22 may reach a surface of the negative electrode lead 21, the surface not being in contact with the negative electrode active material layer 26.

The region on which the alloy layer 22 is formed can be adjusted by selecting the conditions. The conditions include the materials and the thicknesses of the negative electrode current collector 25, the negative electrode active material layer 26 and the negative electrode lead 21, the welding conditions of arc welding, and the like. The position on which the alloy layer 22 is formed may be changed according to the application, shape, and the like of the non-aqueous electrolyte secondary battery 1 to which the negative electrode 4 is to be applied.

The area of the alloy layer 22 can be adjusted by selecting the conditions. The area of the alloy layer 22 is an area of the alloy layer 22 in the orthographic protrusion view thereof in the direction normal to the surface of the negative electrode 4. The conditions include the materials and the thicknesses of the negative electrode current collector 25, the negative electrode active material layer 26 and the negative electrode lead 21, the welding conditions of arc welding, and the like. The area of the alloy layer 22 may be changed according to the application, shape, and the like of the non-aqueous electrolyte secondary battery 1 to which the negative electrode 4 is to be applied.

In this embodiment, four alloy layers 22 which are spaced apart at predetermined intervals are formed along the width direction of the negative electrode plate 20, at one end of the negative electrode plate 20 in the longitudinal direction thereof. The negative electrode plate 21 is bonded to the negative electrode plate 20 in such a manner that one end portion of the negative electrode plate 21 in its longitudinal direction is aligned with one end portion of the negative electrode lead 21 in the width direction thereof. Alternatively, the negative electrode plate 21 may be bonded to the negative electrode plate 20 in such a manner that one end portion of the negative electrode plate 21 in its longitudinal direction is aligned with one end portion of the negative electrode lead 21 in its longitudinal direction. In the latter case, one or a plurality of alloy layers 22 are formed along the longitudinal direction of the negative electrode plate 20.

The negative electrode 4 is formed, for example, by a method of producing a negative electrode comprising the first, second and third steps.

### [First Step]

In this step, the negative electrode active material layer 26 is formed on a surface of the negative electrode current collector 25, to form the negative electrode plate 20. The negative electrode active material layer 26 contains an alloy-based negative electrode active material.

Preferably, the negative electrode active material layer 26 is formed by a vapor phase method. For example, the negative electrode current collector 25 is placed vertically above a silicon target in an electron beam vacuum vapor deposition apparatus. While oxygen, nitrogen, and the like are being supplied as appropriate, the silicon target is irradiated with electron beams to generate silicon vapor, to deposit the generated silicon vapor on the surface of the negative electrode current collector 25. As a result, the negative electrode active material layer 26 including a silicon-based active material such as silicon, a silicon oxide, or a silicon nitride is formed on the surface of the negative electrode current collector 25. The thickness of the negative electrode active material layer 26 is, for example, 5 to 30 μm.

### [Second Step]

In this step, the negative electrode active material layer 26 in the negative electrode plate 20 and the negative electrode lead 21 are brought into contact with each other. FIG. 4 is a longitudinal cross-sectional view explaining a preferred embodiment of the second step and the third step of the method for producing the negative electrode 4 of the present invention. FIG. 4 illustrates an example of boding the negative electrode lead 21 to one end portion of the negative electrode plate 20 in its longitudinal direction. The cross section of the negative electrode plate 20 shown in FIG. 4 is a cross section of the negative electrode plate 20 in its longitudinal direction. The cross section of the negative electrode lead 21 is a cross section of the negative electrode lead 21 in its width direction.

According to the method as shown in FIG. 4, positioning of the negative electrode plate 20 and the negative electrode lead 21 is performed first. The positioning is performed in such a manner that one end surface 20a of the negative electrode plate 20 in its longitudinal direction (hereinafter simply referred to as the “end surface 20a”) and one end surface 21a of the negative electrode lead 21 in its width direction (hereinafter simply referred to as the “end surface 21a”) are adjacent to each other, and the end surface 20a and the end surface 21a form a continuous flat surface. This positioning places the negative electrode active material layer 26 and the negative electrode lead 21 in contact with each other. After the positioning, the negative electrode plate 20 and the negative electrode lead 21 are sandwiched between press jigs 27. For example, a robot may be used as the press jigs 27.

In this step, the negative electrode lead 21 may be positioned such that the end surface 21a of the negative electrode lead 21 protrudes slightly higher than the end surface 20a of the negative electrode plate 20 on the sheet of FIG. 4. The protruding length is not particularly limited, but is preferably 3 mm or less and more preferably 1 mm or less. This further improves the bonding and conductivity provided by the alloy layer 22, between the negative electrode current collector 25 and the negative electrode lead 21.

### [Third Step]

In this step, at least part of the contact portion between the negative electrode active material layer 26 of the negative electrode plate 20 and the negative electrode lead 21 are arc welded. The alloy layer 22 is thus formed between the negative electrode current 25 and the negative electrode lead 21. As a result, the negative electrode current collector 25 and the negative electrode lead 21 are bonded and electrically connected to each other.

Specifically, an electrode for arc welding (not shown) is disposed vertically above the end surfaces 20a and 21a forming a continuous flat surface. Energy is applied from a welding torch of the electrode for arc welding along the direction indicated by an arrow 28. The energy applied from the welding torch is mainly applied to the end surface 20a, the end surface 21a, and the contact point between the end surface 20a and the end surface 21a. The alloy layer 22 is thus formed.

The electrode for arc welding is moved at predetermined intervals along the width direction of the negative electrode plate 20, to perform arc welding. As a result, a plurality of alloy layers 22 is formed, and the negative electrode 4 as shown in FIGS. 1 to 3 is obtained. The arc welding may be performed continuously while the electrode for arc welding is being moved along the width direction of the negative electrode plate 20. In this case, an alloy layer 22 that extends in the width direction of the negative electrode plate 20 is formed on almost the entire region of one end portion of the negative electrode plate 20 in its longitudinal direction.

Among arc welding methods, plasma welding and TIG (Tungsten Inert Gas) welding are preferred. In view of achieving a uniform dispersion of elements in the alloy layer 22, and other factors, plasma welding is particularly preferred. It is presumed that the more uniformly the elements are dispersed in the alloy layer 22, the more the bonding and conductivity provided by the alloy layer 22, between the negative electrode current collector 25 and the negative electrode lead 21 are improved. Plasma welding and TIG welding are performed by using a commercially available plasma welding machine and a commercially available TIG welding machine, respectively.

Plasma welding may be performed under appropriately selected conditions of, for example, the welding current value, the welding rate (i.e., the sweeping speed of the welding torch), the weld time, the types of the plasma gas and the shield gas and the flow rates thereof, and the like. By selecting these conditions, the bonding and conductivity provided by the thus formed alloy layer 22, between the negative electrode current collector 25 and the negative electrode lead 21 can be controlled.

The welding current value is, for example, 1 A to 100 A. The sweeping speed of the welding torch is, for example, 1 mm/sec to 100 mm/sec. For the plasma gas, argon gas and the like may be used. The flow rate of the plasma gas is, for example, 10 mL/min to 10 L/min. For the shield gas, argon, hydrogen, and the like may be used. The flow rate of the shield gas is, for example, 10 mL/min to 10 L/min.

By performing arc welding, the alloy layer 22 can be easily formed at any desired points between the negative electrode current collector 25 and the negative electrode lead 21.

When the negative electrode active material layer 26 includes a silicon-based active material, the method of producing a negative electrode of this embodiment preferably includes a step of allowing the negative electrode active material layer 26 to absorb lithium (hereinafter referred to as the “lithium-absorbing step”), between the first step and the second step. This further improves the uniform dispersion of the alloy in the interior of the alloy layer 22 to be obtained in the third step. In addition, the alloy layer 22 produced by the method including the lithium-absorbing step becomes larger in size than that produced by the method not including the lithium-absorbing step. This means that the areas where the alloy layer 22 is in contact with the negative electrode current collector 25 and the negative electrode lead 21 are increased. As a result, the bonding and conductivity provided by the alloy layer 22, between the negative electrode current collector 25 and the negative electrode lead 21 are further improved.

The negative electrode active material layer 26 is allowed to absorb lithium by, for example, a vacuum vapor deposition method, an electrochemical method, and a method of pasting lithium foil onto a surface of the negative electrode active material layer 26. According to a vacuum vapor deposition method, for example, vacuum vapor deposition is performed while metal lithium is mounted on the target of a vacuum vapor deposition apparatus. The negative electrode active material layer 26 is thus allowed to absorb lithium. The amount of lithium to be absorbed is not particularly limited, but is preferably an amount equivalent to the irreversible capacity of the negative electrode active material layer 26.

When the alloy layer 22 is formed by the production method of a negative electrode comprising the first step, the lithium-absorbing step, the second step, and the third step, there may be a case where the resultant alloy layer 22 contains the alloy (A) and further contains the alloy (B), lithium, a metal element other than lithium, and a semimetal element. The metal element other than lithium is mainly a metal element contained in the negative electrode current collector 25 and/or the negative electrode lead 21. The semimetal element is mainly a semimetal element contained in the alloy-based negative electrode active material.

The description of the non-aqueous electrolyte secondary battery 1 shown in FIG. 1 is resumed.

The separator 5 is arranged between the positive electrode 3 and the negative electrode 4. For the separator 5, for example, a sheet having predetermined levels of ion permeability, mechanical strength, insulating property, and the like may be used. The separator 5 is exemplified by a porous sheet, such as a microporous film, a woven fabric, and a non-woven fabric. The microporous film may be of a single-layer film or of a multi-layer film (a composite film). The single-layer film is made of one material. The multi-layer film (the composite film) is a laminate of a plurality of single-layer films. The plurality of single-layer films are made of the same material or different materials. Further, the separator may be a laminate of two or more layers of a microporous film, a woven fabric, a non-woven fabric film, and the like.

For the material of the separator 5, various resin materials may be used, but polyolefin, such as polyethylene and polypropylene, is preferred in view of the durability, the shutdown function, the safety of the battery, and other factors. Here, the shutdown function is a function that works when the battery temperature is abnormally elevated, in such a way that the pores present in the separator 5 are closed to interrupt the migration of ions, thereby to shut down the battery reaction.

The thickness of the separator 5 is generally 10 to 300 μm, and is preferably 10 to 40 μm, more preferably 10 to 30 μm, and more preferably 10 to 25 μm. The porosity of the separator 5 is preferably 30 to 70%, and more preferably 35 to 60%. Here, the porosity is a percentage of the total volume of pores present in the separator 5 to the volume of the separator 5.

The separator 5 is impregnated with a non-aqueous electrolyte with lithium ion conductivity. Examples of the non-aqueous electrolyte include a liquid non-aqueous electrolyte and a gelled non-aqueous electrolyte.

The liquid non-aqueous electrolyte includes a solute (a support salt) and a non-aqueous solvent, and further includes, as appropriate, various additives. The solute usually dissolves in the non-aqueous solvent. The liquid non-aqueous electrolyte is mainly impregnated into the separator.

The solute may be any solute commonly used in this field, examples of which include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, LiBCl₄, borates, and imides.

Examples of the borates include lithium bis(1,2-benzendiolate(2-)-O,O′) borate, lithium bis(2,3-naphthalenediolate(2-)-O,O′) borate, lithium bis(2,2′-biphenyldiolate(2-)-O,O′) borate, and lithium bis(5-fluoro-2-olate-1-benzenesulfonate-O,O′) borate.

Examples of the imides include lithium bis(trifluoromethane sulfonyl)imide ((CF₃SO₂)₂NLi), lithium (trifluoromethane sulfonyl) (nonafluorobutane sulfonyl)imide ((CF₃SO₂)(C₄F₉SO₂)NLi), and lithium bis(pentafluoroethane sulfonyl) imide ((C₂F₅SO₂)₂NLi). These solutes may be used singly or in combination of two or more. The amount of solute to be dissolved in the non-aqueous solvent is preferably 0.5 to 2 mol/L.

The non-aqueous solvent may be any non-aqueous solvent commonly used in this field, examples of which include cyclic carbonic acid ester, chain carbonic acid ester, and cyclic carboxylic acid ester. Examples of the cyclic carbonic acid ester include propylene carbonate and ethylene carbonate. Examples of the chain carbonic acid ester include diethyl carbonate, ethyl methyl carbonate, and dimethyl carbonate. Examples of the cyclic carboxylic acid ester include γ-butyrolactone and γ-valerolactone. These non-aqueous solvents may be used singly or in combination of two or more.

For the additive, an additive (A), an additive (B), and the like may be used. The additive (A) improves the charge-discharge efficiency by decomposing on the negative electrode to form a coating film with high lithium ion conductivity. Examples of the additive (A) include vinylene carbonate, 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate, and divinylethylene carbonate. In these compounds, some of hydrogen atoms may be replaced with fluorine atoms. These additives (A) may be singly or in combination of two or more.

The additive (B) inactivates a battery by decomposing during overcharge of the battery to form a coating film on the electrode surface. Examples of the additive (B) include benzene derivatives. The benzene derivatives are exemplified by a benzene compound having a phenyl group and a cyclic compound group adjacent to the phenyl group. Examples of the cyclic compound group include a phenyl group, a cyclic ether group, a cyclic ester group, a cycloalkyl group, and a phenoxy group. The benzene derivatives are specifically exemplified by cyclohexyl benzene, biphenyl, diphenyl ether, and the like. These additives (B) may be used singly or in combination of two or more. The content of the additive(s) (B) is preferably equal to or less than 10 parts by volume per 100 parts by volume of the non-aqueous solvent.

The gelled non-aqueous electrolyte includes a liquid non-aqueous electrolyte and a polymer material for retaining the liquid non-aqueous electrolyte. The polymer material converts the liquid non-aqueous electrolyte into gel. The polymer material may be any polymer material commonly used in this field, examples of which include polyvinylidene fluoride, polyacrylonitrile, polyethylene oxide, polyvinyl chloride, and polyacrylate.

The upper insulating plate 6 and the lower insulating plate 7 are formed of an electrically insulative material, and preferably of a resin material or a rubber material. The battery case 8 is a bottomed cylindrical member having an opening at one end in its longitudinal direction. The battery case 8 is formed of a metal material such as iron and stainless steel. The positive terminal 9 is formed of a metal material such as iron and stainless steel. The sealing plate 10 is formed of an electrically insulative material, and preferably of a resin material or a rubber material.

The non-aqueous electrolyte secondary battery 1 is a cylindrical battery including the wound electrode assembly 2, in this embodiment, but is not limited thereto and may be in various forms. For example, it may be a prismatic battery, a flat battery, a coin battery, a laminate film battery, and the like. Further, in place of the wound electrode assembly 2, a stacked electrode assembly may be used. The wound electrode assembly 2 may be formed into a flat shape.

A negative electrode active material layer according to another embodiment of the present invention includes a plurality of columns. The columns include an alloy-based negative electrode active material and extend outward from the surface of the negative electrode current collector. Preferably, the columns are formed so as to extend in the same direction. A gap is present between a pair of columns adjacent to each other, allowing the columns to be spaced from one another. In forming a negative electrode active material layer including a plurality of columns, it is preferable to provide the surface of the negative electrode current collector with a plurality of protrusions and form one column on the surface of each protrusion.

FIG. 5 is a perspective view schematically showing the configuration of a negative electrode current collector 31. FIG. 6 is a longitudinal cross-sectional view schematically showing the configuration of a negative electrode 30 of another embodiment including the negative electrode current collector 31 shown in FIG. 5. FIG. 7 is a longitudinal cross-sectional view schematically showing the configuration of a column 34 included in a negative electrode active material layer 33 of the negative electrode 30 shown in FIG. 6. FIG. 8 is a side view schematically showing the configuration of an electron beam vapor deposition apparatus 40. In FIG. 8, the members in the interior of the vapor deposition apparatus 40 are illustrated by a solid line.

The negative electrode 30 shown in FIG. 6 includes the negative electrode current collector 31 and the negative electrode active material layer 33.

The negative electrode current collector 31 has the same configuration as the negative electrode current collector 25 shown in FIGS. 2 and 4 except that a plurality of protrusions 32 are provided on a surface 31a thereof in the thickness direction. The plurality of protrusions 32 may be provided on each of both surfaces of the negative electrode current collector 31 in its thickness direction.

The protrusions 32 are protruding bodies extending outward from the surface 31a of the negative electrode current collector 31 in its thickness direction (hereinafter simply referred to as the “surface 31a”).

The height of the protrusions 32 is not particularly limited, but is preferably about 3 to 10 μm on average. The height of protrusions 32 as used herein is defined on the basis of the cross sections of the protrusions 32 in the thickness direction of the negative electrode current collector 31. Here, the cross section of each of the protrusions 32 is a cross section including the uppermost end of the protrusion 32 in its extending direction. On the cross section of the protrusion 32, the height of the protrusion 32 is equal to the length of a perpendicular drawn from the uppermost end of the protrusion 32 in its extending direction to the surface 31a. The average height of the protrusions 32 is determined as an average of the heights of, for example, one hundred protrusions 32, obtained by, for example, observing the cross section of the negative electrode current collector 31 in the thickness direction thereof under a scanning electron microscope (SEM) and measuring and averaging the measured values.

The cross-sectional diameter of the protrusions 32 is not particularly limited, but preferably is 1 to 50 μm on average. The cross-sectional diameter of each of the protrusions 32 is equal to the width of the protrusion 32 measured parallel to the surface 31a on the cross section of the protrusion 32 used for measuring the height of the protrusion 32. The cross-sectional diameter of the protrusions 32 is also determined as an average of the widths of one hundred protrusions 32, obtained similarly to the height of the protrusions 32, by measuring and averaging the measured values.

It is not necessary that all of the protrusions 32 have the same height or the same cross-sectional diameter.

The shape of the protrusion 32 is a circle in this embodiment. The shape of the protrusion 32 is a shape of the protrusion 32 on the orthographic view from vertically above of the negative electrode current collector 31 which is placed such that the surface 31a of the negative electrode current collector 31 coincides the horizontal plane. The shape of the protrusion 32 is not limited to a circle and may be a polygon, an ellipse, a parallelogram, a trapezoid, a rhomboid, and the like. In the case of a polygon, polygons from a triangle to an octagon are preferred in view of the production costs and the like, and regular polygons from a regular triangle to a regular octagon are particularly preferred.

The protrusion 32 has an almost flat top surface at its end in the extending direction thereof. This improves the bonding between the protrusions 32 and the columns 34. In order to further improve the bonding strength between the protrusions 32 and the columns 34, the flat surface at the top end is preferably substantially parallel to the surface 31a.

The number of the protrusions 32, the clearance between the adjacent protrusions 32, and the like are not particularly limited, and may be suitably selected according to the size of the protrusions 32 (e.g., the height, the cross-sectional diameter), the size of the columns 34 formed on the surfaces of the protrusions 32, and the like. For example, the number of the protrusions 32 is about 10,000 to 10,000,000 protrusions/cm².

The axis-to-axis distance between a pair of the protrusions 32 adjacent to each other is preferably about 2 μm to 100 μm. When the protrusion 32 has the shape of a circle, the axis of the protrusion 32 is a virtual line passing through the center of the circle and extending along the normal to the surface 31a. When the protrusion 32 has the shape of a polygon, a parallelogram, a trapezoid or a rhomboid, the axis of the protrusion 32 is a virtual line passing through the point of intersection of the diagonals and extending along the normal to the surface 31a. When the protrusion 32 has the shape of an ellipse, the axis of the protrusion 32 is a virtual line passing through the point of intersection of the long and short axes of the ellipse and extending along the normal to the surface 31a.

The protrusions 32 are arranged on the surface 31a in a regular pattern or in an irregular pattern. Examples of the regular pattern include a grid pattern, a close-packed pattern, and a staggered pattern.

The protrusion 32 may have a projection (not shown) formed on its surface. This further improves the bonding between the protrusions 32 and the columns 34, and reliably prevents a separation of the column 34 from the protrusion 32, a spread of the separation, and the like. The projection protrudes outward from the surface of the protrusion 32. A plurality of projections being smaller in size than the protrusions 32 may be formed. The projection may be formed on the side surface of the protrusion 32 so as to extend in the circumferential direction and/or the growing direction of the protrusion 32. One or a plurality of projections may be formed on the flat-shaped top of the protrusion 32.

In forming the projection, for example, photoresist, plating, and the like may be utilized. The projection can be formed by, for example, forming a protruding body for forming a protrusion larger than the design size of the protrusion 32 and etching the protruding body by utilizing photoresist. Alternatively, the projection can be formed by partially plating the surface of the protrusion 32.

In forming the negative electrode current collector 31, for example, a technique for forming protrusions and depressions on a metal sheet may be utilized. Specifically, a method using a roller having depressions formed on its surface (hereinafter referred to as a “roller method”), photoresist, and other methods may be utilized. The metal sheet is, for example, a metal foil. The metal sheet is made of, for example, stainless steel, titanium, nickel, copper, or a copper alloy. In other words, the metal sheet is made of the same material as the negative electrode current collector 25.

According to the roller method, the negative electrode current collector 31 can be formed by mechanically pressing a metal sheet by using a roller having depressions formed on its surface (hereinafter referred to as a “protrusion-forming roller”). The protrusion-forming roller has a plurality of depressions formed on its circumferential surface in a regular or irregular pattern. By using such a roller, the protrusions 32 corresponding to the size of the depressions, the shape of the internal spaces thereof, and the number and arrangement of the depressions can be formed.

When two protrusion-forming rollers are press-fitted with the axes of the two rollers being arranged parallel to each other so that a press fit portion is formed therebetween, and the metal sheet is passed through the press fit portion to be press-molded, a negative electrode current collector having the protrusions 32 formed on both surfaces thereof in its thickness direction can be produced. When one protrusion-forming roller and a roller having a smooth surface are press-fitted with the axes of the two rollers being arranged parallel to each other so that a press fit portion is formed therebetween, and the metal sheet is passed through the press fit portion to be press-molded, the negative electrode current collector 31 having the protrusions 32 formed on one surface thereof in its thickness direction can be produced. The press fitting pressure of rollers is appropriately selected according to the material and thickness of the metal sheet, the shape and size of the protrusions 32, the setting values of the thickness of the negative electrode current collector 31 obtained after press-molding, and the like.

The protrusion-forming roller can be produced by, for example, forming depressions at predetermined positions on the surface of a ceramic roller. The ceramic roller may be, for example, a roller including a core roller and a flame sprayed layer. For the core roller, a roller made of iron, stainless steel, or the like may be used. The flame sprayed layer is formed by uniformly flame spraying a ceramic material such as chromium oxide on the surface of the core roller. The depressions are then formed on the flame sprayed layer. In forming the depressions, a general laser for machining a ceramic material may be used.

A different type of protrusion-forming roller includes a core roller, a base layer, and a flame sprayed layer. The core roller is the same core roller as included in the ceramic roller. The base layer is a resin layer formed on the surface of the core roller, and the depressions are formed on the surface of the base layer. The base layer is made of a synthetic resin preferably having a high mechanical strength, examples of which include thermosetting resins such as unsaturated polyester, thermosetting polyimide, and epoxy resin; and thermoplastic resins such as polyamide, polyetherketone, polyetheretherketone, and fluorocarbon resin.

The base layer is formed by attaching, around the core roller, a resin sheet having depressions on one surface thereof such that the surface without depressions of the resin sheet is in contact with the surface of the core roller. The flame sprayed layer is formed by flame spraying a ceramic material such as chromium oxide on the base layer in conformity with the protrusions and depressions on the surface thereof. For this reason, it is preferable to form the depressions on the base layer so as to have a size larger than the design size of the protrusions 32, by an amount corresponding to the thickness of the flame sprayed layer.

Another different type of protrusion-forming roller includes a core roller and a cemented carbide layer. The core roller is the same core roller as included in the ceramic roller. The cemented carbide layer is formed on the surface of the core roller and includes cemented carbide such as tungsten carbide. The cemented carbide layer can be formed by attaching a cylinder of cemented carbide to the core roller by thermal fitting or cool fitting. In the thermal fitting, the cylinder of cemented carbide is warmed to expand, into which the core roller is inserted. In the cool fitting, the core roller is cooled to shrink, and inserted into the cylinder of cemented carbide. The depressions are formed on the surface of the cemented carbide layer by, for example, laser machining.

Yet another type of protrusion-forming roller is a hard iron-based roller having depressions formed on its surface by laser machining. The hard iron-based roller is a roller used, for example, for rolling a metal foil. Examples of the hard iron-based roller include rollers made of high-speed steel, forged steel, and the like. The high-speed steel is an iron-based material with metals such as molybdenum, tungsten, and vanadium added thereto and heated to increase the hardness. The forged steel is an iron-based material made by heating a steel ingot or a steel slab, and then forging it with presses and hummers, or rolling and forging it, followed by further heating. The steel ingot is made by casting molten steel using a mold. The steel slab is formed from the steel ingot.

According to the photoresist, the negative electrode current collector 31 can be produced by forming a resist pattern on the surface of a metal sheet, and applying a metal plating thereto.

The negative electrode active material layer 33 includes a plurality of the columns 34 each extending outward from the surface of the protrusion 32 on the negative electrode current collector 31, as shown in FIG. 6. The columns 34 grow along the normal to the surface 31a of the negative electrode current collector 31 or along a direction inclined from the normal to the surface 31a. A gap is present between a pair of adjacent columns 34. That is, the columns 34 are spaced apart from each other. Due to the presence of such gaps, the stress generated due to expansion and contraction of the alloy-based negative electrode active material during charge and discharge is reduced. As a result, the columns 34 are unlikely to separate from the protrusions 32, and deformations of the negative electrode current collector 31 and the negative electrode 30 are unlikely to occur.

The column 34 is a stack of eight columnar pieces 34a, 34b, 34c, 34d, 34e, 34f, 34g and 34h, as shown in FIG. 7. The column 34 is formed as follows. First, the columnar piece 34a is formed so as to cover the top of the protrusion 32 and part of the side surface continued therefrom. Then, the columnar piece 34b is formed so as to cover the remaining part of the side surface of the protrusion 32 and part of the top of the columnar piece 34a. That is, the columnar piece 34a is formed on one edge of the protrusion 32 that includes the top of the protrusion 32; and the columnar piece 34b is formed on the other edge of the protrusion 32 with part of the columnar piece 34b overlapping the columnar piece 34a.

The columnar piece 34c is formed so as to cover the remaining part of the top of the columnar piece 34a and part of the top of the columnar piece 34b, so that the columnar piece 34c is mainly in contact with the columnar piece 34a. Further, the columnar piece 34d is formed so as to be mainly in contact with the columnar piece 34b. By stacking the columnar pieces 34e, 34f, 34g and 34h one after another in the same manner as described above, the column 34 is formed. The number of stacking of the columnar pieces is not limited to eight, and may be any number of two or more.

The column 34 can be formed by, for example, an electron beam vapor deposition apparatus 40 as shown in FIG. 8. The vapor deposition apparatus 40 includes a chamber 41, a first pipe 42, a support table 43, a nozzle 44, a target 45, an electron beam generating apparatus (not shown), a power source 46, and a second pipe (not shown).

The chamber 41 is a pressure-resistant container and accommodates in its interior the first pipe 42, the support table 43, the nozzle 44, the target 45, and the electron beam generating apparatus. One end of the first pipe 42 is connected to the nozzle 44, and the other end extends outside the chamber 41 and is connected to a raw material gas tank or a raw material gas producing apparatus (not shown) via a mass flow controller (not shown). The raw material gas may be oxygen, nitrogen, and the like. The first pipe 42 supplies the raw material gas to the nozzle 44.

The support table 43 is a rotatably supported board-like member and can hold the negative electrode current collector 31 on one surface in the thickness direction thereof (a support surface) in a fixed manner. The support table 43 is tilted alternately so as to move between the positions indicated by the solid line and by the dot-dash line. The position indicated by the solid line is a position where the support surface of the support table 43 faces the nozzle 44, and the support table 43 and the horizontal line intersect at an angle of a°. The position indicated by the dash-dot line is a position where the support surface of the support table 43 faces the nozzle 44, and the support table 43 and the horizontal line intersect at an angle of (180−α)°. The angle α° can be appropriately selected according to the size of the column 34, and the like.

The nozzle 44 is provided vertically between the support table 43 and the target 45, and one end of the first pipe 42 is connected thereto. The nozzle 44 supplies the raw material gas into the chamber 41. The target 45 holds a raw material such as silicon and tin. The electron beam generating apparatus irradiates the target 45 with electron beams, to generate vapor of the raw material.

The power source 46 is provided outside the chamber 41, and applies a voltage to the electron beam generating apparatus. The second pipe introduces a gas into the chamber 41, the gas forming the atmosphere therein. An electron beam vapor deposition apparatus having the same configuration as that of the vapor deposition apparatus 40 is commercially available from, for example, Ulvac Inc.

The operation of the electron beam vapor deposition apparatus 40 is described, assuming that silicon is used as the raw material, and oxygen is used as the raw material gas. First, the negative electrode current collector 31 is fixed on the support table 43, and oxygen is introduced into the chamber 41. Next, the target 45 is irradiated with electron beams, to generate vapor of silicon therefrom. The vapor of silicon goes up vertically, and, while passing through near the nozzle 44, is mixed with oxygen, forming a mixed gas. This mixed gas further goes up vertically to be supplied to the surface of the negative electrode current collector 31. As a result, a layer containing silicon and oxygen is formed on the surfaces of the protrusions 32 (not shown).

When the support table 43 is in the position indicated by the solid line, the columnar pieces 34a as shown in FIG. 7 are formed on the surfaces of the protrusions 32. Subsequently, the support table 43 is tilted to the position indicated by the dash-dot line, and the columnar pieces 34b as shown in FIG. 7 are formed. By changing the position of the support table 43 alternately in this way, the columns 34, each of which is a stack of eight columnar pieces 34a, 34b, 34c, 34d, 34e, 34f, 34g and 34h as shown in FIG. 7, are consecutively formed on the surface of the protrusions 32, and thus the negative electrode active material layer 33 is obtained.

When the negative electrode active material is, for example, a silicon oxide represented by SiO, where 0.05<a<1.95, the columns 34 may be formed so that the columns 34 each have a concentration gradient of oxygen in the thickness direction thereof. Specifically, the oxygen content is made higher near the negative electrode current collector 31, and is decreased with distance away from the negative electrode current collector 31. This further improves the bonding between the protrusions 32 and the columns 34. When the raw material gas is not supplied from the nozzle 44, the columns 34 mainly composed of elementary silicon or tin are formed.

### EXAMPLES

The present invention is described below with reference to Examples and Comparative Examples.

### Example 1

### (1) Preparation of Positive Electrode Active Material

To an aqueous NiSO₄ solution, cobalt sulfate was added such that Ni:Co=8.5:1.5 (molar ratio), to prepare an aqueous solution having a metal ion concentration of 2 mol/L. To the resultant aqueous solution, a 2 mol/L sodium hydroxide solution was gradually added dropwise to neutralize the solution, and a ternary precipitate represented by Ni_{0.85}CO_{0.15}(OH)₂ was thus produced by coprecipitation. The precipitate was collected by filtration, washed with water, and dried at 80° C., to give a composite hydroxide.

The resultant composite hydroxide was heated at 900° C. in air for 10 hours, to give a composite oxide represented by Ni_{0.85}Co_{0.15}O₂. Subsequently, the composite oxide was mixed with a monohydrate of lithium hydroxide such that the total number of Ni and Co atoms became equal to the number of Li atoms, and heated at 800° C. in air for 10 hours, to give a lithium-nickel-containing composite oxide represented by LiNi_{0.85}CO_{0.15}O₂. In such a manner, a positive electrode active material comprising secondary particles having an average particle diameter of 10 μm was obtained.

### (2) Production of Positive Electrode

First, 93 g of the positive electrode active material powder obtained in the above, 3 g of acetylene black (conductive agent), 4 g of polyvinylidene fluoride powder (binder), and 50 mL of N-methyl-2-pyrrolidone were mixed sufficiently to prepare a positive electrode material mixture slurry. The positive electrode material mixture slurry thus prepared was applied onto both surfaces of a 15-μm-thick aluminum foil (positive electrode current collector), then dried and rolled, to form a positive electrode active material layer having a thickness of 50 μm on each of both surfaces of the foil. A positive electrode plate of 56 mm×205 mm in size was thus formed. A portion (56 mm×5 mm) of each of the positive electrode active material layers on both surfaces was removed to form a positive electrode current collector-exposed portion, to which a positive electrode lead made of aluminum was connected by ultrasonic welding. In such a manner, a positive electrode was produced.

### (3) Formation of Negative Electrode Plate

FIG. 9 is a side view schematically showing the configuration of a different type of vapor deposition apparatus 50. In FIG. 9, the members in the interior of the vapor deposition apparatus 50 are illustrated by a solid line.

The vapor deposition apparatus 50 includes a vacuum chamber 51, a conveying means 52, a gas supplying means 58, a plasma generating means 59, silicon targets 60a and 60b, a masking plate 61, and an electron beam generating means (not shown).

The vacuum chamber 51 is a pressure-resistant container and accommodates in its interior the conveying means 52, the gas supplying means 58, the plasma generating means 59, the silicon targets 60a and 60b, the masking plate 61, and the electron beam generating means.

The conveying means 52 includes a feed roller 53, a can 54, a pickup roller 55, and guide rollers 56 and 57. These rollers are provided so as to be rotatable around their axes. On the feed roller 53, a belt-like negative electrode current collector 25 is wound around. The can 54 has a larger diameter than the other rollers and has a cooling means (not shown) in its interior. While the negative electrode current collector 25 is being conveyed on the surface of the can 54, the negative electrode current collector 25 is cooled. In this process, the vapor of the alloy-based negative electrode active material precipitates, and thus the negative electrode active material layer 26 is formed.

The pickup roller 55 is rotatable around its axis by a driving means (not shown). One end of the negative electrode current collector 25 is fixed onto the pickup roller 55, and by the rotation of the pickup roller 55, the negative electrode current collector 25 is fed from the feed roller 53 and conveyed on the guide roller 56, the can 54, and the guide roller 57. Then, the negative electrode plate 20 comprising the negative electrode current collector 25 and the negative electrode active material layer 26 formed thereon is wound on the pickup roller 55.

The gas supplying means 58 supplies a raw material gas such as oxygen and nitrogen into the vacuum chamber 51. When the raw material gas is supplied from the gas supplying means 58, a negative electrode active material layer 26 mainly composed of an oxide, nitride, or the like of silicon or tin is formed. The plasma generating means 59 allows the raw material gas supplied from the gas supplying means 58 to form plasma thereof. The silicon targets 60a and 60b are used for forming a negative electrode active material layer 26 including silicon.

The masking plate 61 is provided so as to be movable in the horizontal direction vertically between the can 54 and the silicon targets 60a and 60b. The position in the horizontal direction of the masking plate 61 is appropriately adjusted according to the growing state of the negative electrode active material layer 26 on the surface of the negative electrode current collector 25. The electron beam generating means irradiates the silicon targets 60a and 60b with electron beams, to generate vapor of silicon therefrom.

By using the vapor deposition apparatus 50, a negative electrode active material layer 26 (here, a silicon thin film) having a thickness of 5 μm was formed on each of both surfaces of the negative electrode current collector 25 under the following conditions, thereby to form the negative electrode plate 20.

Pressure in vacuum chamber 51: 8.0×10⁻⁵ Torr

Negative electrode current collector 25: electrolytic copper foil with roughened surface (available from FURUKAWA CIRCUIT FOIL Co., Ltd.)

Rate of winging of negative electrode current collector 25 on pickup roller 55 (conveying rate of negative electrode current collector 25): 2 cm/min

Raw material gas: not supplied

Targets 60a and 60b: single crystal silicon with 99.9999% purity (available from Shin-Etsu Chemical Co., Ltd.)

Accelerating voltage of electron beams: −8 kV

Emission of electron beams: 300 mA

The obtained negative electrode plate 20 was cut in the size of 58 mm×210 mm, and on the surface of the negative electrode active material layer 26, lithium metal was vapor deposited. By vapor depositing lithium metal, lithium was supplemented in the negative electrode active material layer 26 in an amount equivalent to the irreversible capacity stored during initial charge and discharge. The vapor deposition of lithium metal was performed in an argon atmosphere using a resistance heating vapor deposition apparatus (available from ULVAC, Inc.) in the following manner. Lithium metal was placed on the tantalum boat in the resistance heating vapor deposition apparatus, and the negative electrode plate 20 was fixed such that the negative electrode active material layer 26 faced the tantalum boat. The vapor deposition was carried out for 10 minutes in an argon atmosphere, while a current of 50 A was being allowed to flow through the tantalum boat.

### (4) Bonding of Negative Electrode Lead

To the negative electrode plate obtained in the above, a 5-mm-wide, 70-mm-long and 26-μm-thick negative electrode lead made of copper foil (trade name: HCL-02Z, available from Hitachi Cable, Ltd.) was bonded by plasma welding in the manner as described below, to produce a negative electrode of the present invention.

First, the negative electrode plate and the negative electrode lead were placed at positions where they were adjacent to each other. Specifically, they were positioned such that one end surface of the negative electrode plate in its longitudinal direction and one end surface of the negative electrode lead in its width direction formed a single continuous flat surface, and the direction perpendicular to the flat surface thus formed was aligned with the vertical direction, so that the flat surface was directed vertically upward. The negative electrode plate and the negative electrode lead thus positioned were secured using a single axis robot (press jigs, available from IAI Corporation). The negative electrode plate and the negative electrode lead were secured such that the flat surface protruded by 0.5 mm vertically upward from the vertically upper end of the single axis robot.

Next, a plasma welding machine (trade name: PW-50NR, available from KOIKE SANSO KOGYO Co., LTD.) was disposed vertically above the flat surface. Energy was applied from the torch of the plasma welding machine perpendicularly to the flat surface. The torch was moved at equal intervals in the width direction of the negative electrode plate, and at the point where the torch was stopped, energy was applied to the flat surface under the conditions as described below, to form an alloy layer. A negative electrode of the present invention was thus produced.

Electrode rod: 1.0 mm in diameter

Electrode nozzle: 1.6 mm in diameter

Distance between torch and workpiece: 2.0 mm

Sweeping speed of torch: 30 mm/s

Plasma gas: argon

Plasma gas flow rate: 100 (sccm)

Shielding gas: hydrogen, argon

Shielding gas flow rate (hydrogen): 500 (sccm)

Shielding gas flow rate (argon): 1 (slm)

Welding current: 8.0 A

The plasma welding was followed by cooling at room temperature. The cooled flat surface was observed under a scanning electron microscope (brand name: 3D Real Surface View Microscope, available from KEYENCE CORPORATION). The result showed that a plurality of alloy layers were formed between the negative electrode current collector and the negative electrode lead. FIG. 10 is a scanning electron micrograph of a cross section of an alloy layer in the negative electrode of the present invention. FIG. 10 clearly shows that the almost entire region of the alloy layer has a uniform structure.

An energy dispersive X-ray analyzer (trade name: Genesis XM2, available from EDAX Inc.) was mounted on the scanning electron microscope, and the cross section of the alloy layer was analyzed to obtain element maps of copper and silicon. FIG. 11 is an element map of copper in the cross section of the alloy layer shown in FIG. 10. FIG. 12 is an element map of silicon in the cross section of the alloy layer shown in FIG. 10. In FIGS. 11 and 12, the copper concentration and the silicon concentration are converted into brightness (grayscale) by the energy dispersive X-ray analyzer.

From FIGS. 11 and 12, it is clear that copper and silicon are present in the almost entire region of the cross section of the alloy layer. The element molar ratios of copper and silicon were measured in a predetermined portion of the alloy layer with the energy dispersive X-ray analyzer, and the result found that the ratio of copper was 91 mol % and the ratio of silicon was 9 mol %. These results indicate that the silicon was dispersed in the copper, forming an alloy.

The cross section of the alloy layer was subjected to qualitative analysis with a micro X-ray diffractometer (trade name: RINT 2500, available from Rigaku Industrial Corp.). As a result, a peak attributed to copper and a peak attributed to Cu₅Si were identified from the alloy layer. This indicates that the alloy layer contains Cu₅Si alloy.

The cross section of the alloy layer was analyzed with an Auger electron spectroscopy analyzer (trade name: MODEL 670, available from ULVAC PHI Inc.), to obtain an element map of lithium. In the periphery of the cross section of the alloy layer, the cross sections of the negative electrode active material layer and the silicon layer were present, the cross sections being much smaller in size than the cross section of the alloy layer. Lithium was present in these cross sections but was not present in the copper and the copper alloy. Here, the above negative electrode active material layer is a portion that remains unmelted. The above silicon layer is a portion that has melted and resolidified without being alloyed.

The foregoing analysis results found that copper and a copper-silicon alloy including Cu₅Si were present in the alloy layer, and silicon and lithium were present in the periphery of the cross section of the alloy layer.

### (5) Fabrication of Battery

The positive electrode and the negative electrode obtained in the above were stacked with a polyethylene microporous film (separator, trade name: Hipore, thickness 20 μm, available from Asahi Kasei Corporation) interposed therebetween, and a resultant stack was wound to form a wound electrode assembly. The other end of the positive electrode lead was welded to a positive electrode terminal, and the other end of the negative electrode lead was welded to the bottom inner surface of a bottomed cylindrical battery case made of iron. An upper insulator plate and a bottom insulator plate both of which were made of polyethylene were placed on one end and the other end of the electrode assembly in its longitudinal direction, respectively, and these were accommodated in the battery case.

Next, a non-aqueous electrolyte obtained by dissolving LiPF₆ at a concentration of 1.0 mol/L in a mixed solvent containing ethylene carbonate and ethyl methyl carbonate at a ratio of 1:1 by volume was injected into the battery case. Then, a sealing plate was attached to the opening of the battery case with a gasket made of polyethylene interposed therebetween, and the opening end of the battery case was crimped inward to seal the battery case. A cylindrical non-aqueous electrolyte secondary battery of the present invention was thus fabricated.

### Example 2

### (1) Production of Positive Electrode

A positive electrode material mixture slurry was prepared in the same manner as in Example 1. The positive electrode material mixture slurry was applied onto one surface of a 15-μm-thick aluminum foil (a positive electrode current collector), dried and rolled, to form a positive electrode active material layer having a thickness of 50 μm. A positive electrode plate was thus obtained. The positive electrode plate was cut in the size of 30 mm×35 mm, and then a portion (5 mm×30 mm) in the end portion of the positive electrode active material layer was removed to form a positive electrode current collector-exposed portion. A positive electrode lead made of aluminum was welded to the positive electrode current collector-exposed portion by ultrasonic welding, to produce a positive electrode.

### (2) Production of Negative Electrode

On the surface of an iron roller having a diameter of 50 mm, chromium oxide was flame sprayed to form a ceramic layer having a thickness of 100 μm. On the surface of the ceramic layer thus formed, holes being circular depressions each having a diameter of 12 μm and a depth of 8 μm were formed by laser machining, to give a projection-forming roller. These holes were arranged in a close-packed pattern, with an axis-to-axis distance between a pair of adjacent holes being 20 μm. The center of the bottom of each hole was substantially flat, and the edge thereof where the bottom met the side of the hole was round.

An alloy copper foil (trade name: HCL-02Z, thickness: 20 μm, available from Hitachi Cable) containing 0.03 wt % of zirconium to the total amount was heated in an argon gas atmosphere at 600° C. for 30 minutes for annealing. The resultant alloy copper foil was passed through the press-contact portion at which the projection-forming roller and a 50-mm-diameter roller made of forged steel were press-fitted to each other, at a line pressure of 1 t/cm, to press-mold both surfaces of the alloy copper foil. A negative electrode current collector having protrusions on one surface thereof was thus produced. The average height of the protrusions was about 8 μm.

On the protrusions formed on both surfaces of the negative electrode current collector, columns each of which is a stack of eight columnar pieces as shown in FIGS. 6 and 7 were formed using a commercially available vapor deposition apparatus (available from ULVAC, Inc.) having the same structure as the electron beam vapor deposition apparatus 40 as shown in FIG. 8, to form a negative electrode plate. Conditions for vapor deposition were as follows. The support table on which a negative electrode current collector of 35 mm×35 mm in size was fixed tilted alternately so as to move between the positions indicated by the solid line in FIG. 8 (angle α=60°) and indicated by the dash-dot line in FIG. 8 (angle 180−α=120°).

Raw material of negative electrode active material (evaporation source): silicon with 99.9999% purity, available from Kojundo Chemical Laboratory Co., Ltd.

Oxygen released from nozzle: oxygen with 99.7% purity, available from Nippon Sanso Corporation

Flow rate of oxygen released from nozzle: 80 sccm

Angle α: 60°

Accelerating voltage of electron beams: −8 kV

Emission: 500 mA

Duration of vapor deposition: 3 minutes

The thickness of the negative electrode active material layer was 16 μm. The thickness of the negative electrode active material layer was determined as an average of the lengths of ten columns formed on the protrusions, by observing a cross section of the negative electrode in its thickness direction under a scanning electron microscope to measure the length from the highest point of a protrusion to the highest point of the column on the protrusion and averaging the ten measured values. Further, the contents of oxygen in the columns were determined by a combustion method. The result found that the columns had a composition of SiO_{0.5}.

Next, lithium metal was vapor deposited on the surface of the negative electrode active material layer. By vapor depositing lithium metal, lithium was supplemented in the negative electrode active material layer in an amount equivalent to the irreversible capacity stored during initial charge and discharge. The vapor deposition of lithium metal was performed in an argon atmosphere using a resistance heating vapor deposition apparatus (available from ULVAC, Inc.). Lithium metal was placed in the tantalum boat in the resistance heating vapor deposition apparatus, and the negative electrode was fixed such that the negative electrode active material layer faced the tantalum boat. Then, the vapor deposition was carried out for 10 minutes in an argon atmosphere, while a current of 50 A was allowed to flow through the tantalum boat.

To the negative electrode plate thus obtained, a 5-mm-wide, 70-mm-long and 26-μm-thick negative electrode lead made of copper foil (HCL-02Z) was bonded by plasma welding in the same manner as in Example 1, to produce a negative electrode of the present invention.

### (3) Fabrication of Battery

The positive electrode and the negative electrode obtained in the above were stacked with a separator (a polyethylene microporous film, thickness 20 μm, available from Asahi Kasei Corporation) interposed therebetween, to form a stacked electrode assembly. Here, the positive electrode and the negative electrode were arranged such that the positive electrode active material layer and the negative electrode active material layer faced each other with the separator interposed therebetween. The electrode assembly was inserted together with an electrolyte into a battery case made of aluminum laminate sheet from the opening thereof. For the electrolyte, a non-aqueous electrolyte obtained by dissolving LiPF₆ at a concentration of 1.0 mol/L in a mixed solvent containing ethylene carbonate and ethyl methyl carbonate at a ratio of 1:1 by volume was used. Then, the free ends of the positive electrode lead and the negative electrode lead were guided outside the battery case from the opening of the battery case. Subsequently, the opening of the battery case was heated and sealed by thermal welding, to produce a non-aqueous electrolyte secondary battery of the present invention.

### Example 3

A non-aqueous electrolyte secondary battery of the present invention was fabricated in the same manner as Example 2, except that lithium was not vapor deposited on the negative electrode active material layer.

The areas where the alloy layer is in contact with the negative electrode current collector and the negative electrode lead varied in the length direction, and the negative electrode current collector and the negative electrode lead were partially bonded to each other. There was a region where the negative electrode plate or the negative electrode lead melted alone, and the negative electrode plate and the negative electrode lead were not bonded to each other. The resultant alloy layer was smaller in size than the alloy layer of Example 1.

A cross section of the alloy layer was observed in the same manner as in Example 1 under a scanning electron microscope (3D Real Surface View Microscope) with an energy dispersive X-ray analyzer (Genesis XM2) was mounted thereon, to obtain element maps of copper and silicon. The result found that copper and silicon were present in the almost entire region of the cross section of the alloy layer. The silicon was distributed less uniformly than that in the alloy layer of Example 1.

Next, the cross section of the alloy layer was subjected to qualitative analysis with a micro X-ray diffractometer (RINT 2500). The result found that the alloy layer was mainly composed of Cu—Si alloy (Cu₅Si), and additionally contains copper (metal element component) and silicon (semimetal element component).

### Comparative Example 1

A cylindrical non-aqueous electrolyte secondary battery was fabricated in the same manner as Example 1 except that the negative electrode lead was bonded to the negative electrode current collector by resistant welding instead of by plasma welding. Here, the negative electrode was produced in the manner as described below.

### [Production of Negative Electrode]

First, a negative electrode plate obtained in the same manner as in Example 1 and a negative electrode lead made of copper (width: 4 mm, length: 70 mm, thickness: 100 μm) were arranged to be adjacent to each other in such a manner that an end surface of the negative electrode plate along its width direction and an end surface of the negative electrode lead along its longitudinal direction formed a single continuous flat surface. The negative electrode plate and the negative electrode lead thus arranged were sandwiched between electrode rods each having a tip end diameter of 2 mm, and spot welding was performed with a current value set to 1.3 kA using a resistance welding machine (available from Miyachi Corporation), to produce a negative electrode.

### Test Example 1

The non-aqueous electrolyte secondary batteries obtained in Examples 1 to 3 and Comparative Example 1 were subjected to an evaluation test as described below.

### [Bonding Strength Between Negative Electrode Current Collector and Negative Electrode Lead]

The bonding strengths between the negative electrode current collector and the negative electrode lead of the negative electrodes obtained in Examples 1 to 3 and Comparative Example 1 were measured in the manner as described below. FIG. 13 is a set of perspective views schematically showing a method of preparing a sample used for measuring a tensile strength of the negative electrode lead 21 from the negative electrode current collector. FIG. 14 is a perspective view schematically showing a method of measuring a tensile strength of the negative electrode lead 21 from the negative electrode current collector.

As shown in FIG. 13(a), the negative electrode lead 21 was cut so that the length of the negative electrode lead 21 was equal to the width of the negative electrode plate 20. Next, the negative electrode plate 20 was cut so that the length of the negative electrode plate 20 measured from the edge of the portion to which the negative electrode lead 21 was bonded was 30 mm. Then, the bonding width d was measured. The bonding width d is a length of the alloy layer 22 in the width direction of the negative electrode plate 20.

When a plurality of alloy layers 22 are formed at predetermined intervals, the bonding width d is a distance between an alloy layer 22 formed at one end of the negative electrode plate 20 in its width direction and an alloy layer 22 formed at the other end thereof. In this case, the lengths of the alloy layers 22 formed at one end and at the other end are included in the bonding width d. The bonding widths d in the negative electrodes obtained in Examples 1 to 3 and Comparative Example 1 were 30 mm. Subsequently, as shown in FIG. 13(b), the negative electrode lead 21 was pulled and folded in the direction indicated by an allow 66. A sample 65 for measuring a tensile strength was thus prepared.

The sample 65 obtained in the above was used to measure a tensile strength by the measuring method as shown FIG. 14. An end portion of the negative electrode plate 20 where no alloy layer 22 was formed was cramped by a lower cramping jig 71 of a universal tester (available from Shimadzu Corporation) 70, and an end portion of the negative electrode lead 21 (an end portion in the folded side) where no alloy layer 22 was formed was cramped by an upper cramping jig 72. The upper cramping jig 72 was moved in the direction indicated by an arrow 73 at a speed of 5 mm/min at room temperature of 25° C., to pull the negative electrode lead 21. The tensile strength (N) when the bonded portions (the alloy layers 22) between the negative electrode plate 20 and the negative electrode lead 21 were broken were measured. From the tensile strength thus measured and the bonding width d measured in the above, the tensile strength (N/mm) per mm of the bonding width was calculated. The results are shown in Table 1.

### [Conductivity Between Negative Electrode Current Collector and Negative Electrode Lead]

The bonding resistances between the negative electrode current collector and the negative electrode lead of the negative electrodes obtained in Examples 1 to 3 and Comparative Example 1 were measured in the manner as described below. The negative electrode active material layer in the vicinity of the negative electrode lead was removed with sandpaper. Next, the bonding resistance between the exposed negative electrode current collector and the negative electrode lead was measured with a milliohm meter (trade name: Milliohm HiTESTER 3540, available from HIOKI E.E. Corporation). The results are shown in Table 1.

TABLE 1

| | Tensile | Tensile | |
|---|---|---|---|
| | strength | strength | Conductivity |
| | (N) | (N/mm) | (mΩ) |
| Example 1 | 58 | 1.9 | 0.9 |
| Example 2 | 55 | 1.8 | 0.8 |
| Example 3 | 25 | 0.83 | 1.8 |
| Comparative | 0.5 | — | Unmeasurable |
| Example 1 | | | |

The results of Examples 1 to 3 shown in Table 1 indicate that good bonding and conductivity between the negative electrode current collector and the negative electrode lead are obtained by bonding the negative electrode current collector and the negative electrode lead via the alloy layer. Comparison between Examples 1 to 2 and Example 3 indicates that the bonding and conductivity are further improved by allowing the negative electrode active material layer to absorb lithium and then forming an alloy layer to bond the negative electrode current collector and the negative electrode lead. In contrast, in Comparative Example 1 in which resistant welding was performed, bonding was not formed so as to establish electrical connection. It is understood from this that the negative electrode lead cannot be bonded to the negative electrode current collector by resistance welding

### Test Example 2

The non-aqueous electrolyte secondary batteries obtained in Examples 1 to 3 and Comparative Example 1 were subjected to an evaluation test as described below.

### [Cycle Characteristics]

Each of the batteries obtained in Examples 1 to 3 and Comparative Example 1 was placed in a constant temperature bath at 20° C., and charged by a constant-current constant-voltage system as described below.

Each battery was charged at a constant current of 1 C rate (1 C is a value of current at which the whole battery capacity can be consumed in one hour) until the battery voltage reached 4.2 V. After the battery voltage reached 4.2 V, the battery was charged at a constant voltage of 4.2 V until the current value reached 0.05 C. The charged battery was allowed to stand for 20 minutes, and then discharged at a high-rate constant current of 1 C rate until the battery voltage reached 2.5 V. Such a charge-discharge cycle was repeated 100 cycles in total.

The ratio of a whole discharge capacity at the 100th cycle to a whole discharge capacity at the 1st cycle was determined as a percentage. The value thus determined is shown in Table 2 as a capacity retention rate.

TABLE 2

| | Capacity retention rate |
|---|---|
| | (%) |
| Example 1 | 81 |
| Example 2 | 90 |
| Example 3 | 89 |
| Comparative Example 1 | 0 |

The battery of Example 1 to 3 exhibited good cycle characteristics. In particular, the batteries of Examples 2 and 3 exhibited further higher capacity retention rates. In the batteries of Examples 2 and 3, the negative electrode active material layer includes a plurality of columns, and a gap is present between a pair of columns adjacent to each other. Presumably because of this, the expansion of the alloy-based negative electrode active material was suppressed, resulting in a further improvement of the cycle characteristics.

In contrast, electrical connection was not established in the battery of Comparative Example 1, and the resistance became infinite. This was presumably because the lead was separated from the negative electrode active material in the process of battery assembling, falling in an electrically disconnected state.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The negative electrode of the present invention is suitably applicable as a negative electrode of a non-aqueous electrolyte secondary battery. The non-aqueous electrolyte secondary battery of the present invention is applicable for the same applications as those of the conventional non-aqueous electrolyte secondary batteries, and is particular useful as a power source for portable electronic devices. Examples of the portable electronic devices include personal computers, cellular phones, mobile devices, personal digital assistants (PDAs), portable game machines, and video cameras. The non-aqueous electrolyte secondary battery of the present invention is expected to be used as a main power source or an auxiliary power source for hybrid electric vehicles, electric vehicles, fuel cell-powered vehicles, and the like, a power source for driving electric tools, vacuum cleaners, robots, and the like, a power source for plug-in HEVs, and other applications.

1. A negative electrode comprising:
a negative electrode current collector;
a thin film-like negative electrode active material layer formed on a surface of the negative electrode current collector and including an alloy-based negative electrode active material;
a negative electrode lead containing at least one metal or alloy selected from the group consisting of nickel, nickel alloys, copper, and copper alloys; and
an alloy layer interposed between the negative electrode current collector and the negative electrode lead, to bond the negative electrode current collector and the negative electrode lead.

2. The negative electrode in accordance with claim 1, wherein the bonding strength between the negative electrode current collector and the negative electrode lead measured as a tensile strength of the negative electrode lead from the negative electrode current collector is 0.3 N or more per mm of bonding width.

3. The negative electrode in accordance with claim 1, wherein at least part of the alloy layer is in contact with the thin film-like negative electrode active material layer.

4. The negative electrode in accordance with claim 1, wherein the alloy layer has an electric resistance lower than that of the thin film-like negative electrode active material layer.

5. The negative electrode in accordance with claim 1, wherein the alloy-based negative electrode active material includes a semimetal element, at least one selected from the negative electrode current collector and the negative electrode lead includes a metal element, and the alloy layer contains an alloy of the semimetal element and the metal element.

6. The negative electrode in accordance with claim 5, wherein the semimetal element is at least one selected from silicon and tin.

7. The negative electrode in accordance with claim 5, wherein the metal element is at least one selected from copper and nickel.

8. A method for producing a negative electrode, the method comprising:
a first step of forming a thin film-like negative electrode active material layer including an alloy-based negative electrode active material, on a surface of a negative electrode current collector, to prepare a negative electrode plate;
a second step of bringing the thin film-like negative electrode active material layer into contact with a negative electrode lead containing at least one metal or alloy selected from the group consisting of nickel, nickel alloys, copper, and copper alloys; and
a third step of arc welding at least part of a portion where the thin film-like negative electrode active material layer is in contact with the negative electrode lead.

9. The method for producing a negative electrode in accordance with claim 8, wherein in the second step, the negative electrode plate and the negative electrode lead are positioned such that an end surface of the negative electrode plate and an end surface of the negative electrode lead are adjacent to each other.

10. The method for producing a negative electrode in accordance with claim 8, wherein in the third step, at least part of a portion where the end surface of the negative electrode plate and the end surface of the negative electrode lead are adjacent to each other is arc welded.

11. The method for producing a negative electrode in accordance with claim 8, wherein the arc welding is plasma welding or tungsten inert gas welding.

12. The method for producing a negative electrode in accordance with claim 8 further comprising a step provided between the first step and the second step, the step being a step of allowing the thin film-like negative electrode active material layer prepared in the first step to absorb lithium.

13. A non-aqueous electrolyte secondary battery comprising:
a positive electrode including a positive electrode current collector, a positive electrode active material layer being formed on a surface of the positive electrode current collector and including a positive electrode active material, and a positive electrode lead bonded to the positive electrode current collector;
the negative electrode of claim 1;
a separator interposed between the positive electrode and the negative electrode;
a non-aqueous electrolyte with lithium ion conductivity; and
a battery case.
